(19) United States
(12) Patent Application Publication
(10) Pub. No.: US 2024/0248312 A1
(43) Pub. Date: Jul. 25, 2024

(54) IMAGING LIGHT GUIDE APPARATUS WITH LIGHT SECURITY

(71) Applicant: Vuzix Corporation, West Henrietta, NY (US)

(72) Inventors: Robert J. Schultz, Victor, NY (US); Stephen P. McGrew, Spokane, WA (US); Robert W. Gray, Rochester, NY (US)

(21) Appl. No.: 18/606,886

(22) Filed: Mar. 15, 2024

Related U.S. Application Data
(63) Continuation-in-part of application No. PCT/US2022/043719, filed on Sep. 15, 2022.
(60) Provisional application No. 63/278,991, filed on Nov. 12, 2021.
(60) Provisional application No. 63/244,712, filed on Sep. 15, 2021.
(60) Provisional application No. 63/524,614, filed on Jun. 30, 2023.

(51) Int. Cl. G02B 27/01; G02F 1/1335

(52) U.S. Cl. CPC G02B 27/0172; G02F 1/133531; G02B 2027/0118; G02B 2027/0174

(57) ABSTRACT

A light secure image light guide including an image source operable to generate image-bearing light beams and a waveguide operable to propagate the image-bearing light beams. An in-coupling diffractive optic formed along the waveguide, wherein the in-coupling diffractive optic is operable to diffract a portion of the image-bearing light beams from the image source into the waveguide in an angularly encoded form, and an out-coupling diffractive optic formed along the waveguide, wherein the out-coupling diffractive optic is operable to expand the portion of image-bearing light beams, direct a first portion of expanded image-bearing light beams from the waveguide in an angularly decoded form in a first direction toward an eyebox, and direct a second portion of expanded image-bearing light beams from the waveguide in a second direction different from said first direction. The image light guide further including an optical device operable to reduce, eliminate, and/or block the second portion of expanded image-bearing light beams output from the image light guide in the second direction.

### CROSS-REFERENCE TO RELATED APPLICATIONS

This patent application is a continuation-in-part under 35 U.S.C. § 111(a) of International Patent Application No. PCT/US2022/043719, filed Sep. 15, 2022, entitled “IMAGING LIGHT GUIDE APPARATUS WITH LIGHT SECURITY”, which claims the priority benefit of U.S. Provisional Patent Application No. 63/244,712, filed Sep. 15, 2021, entitled “IMAGING LIGHT GUIDE APPARATUS WITH LIGHT SECURITY” and U.S. Provisional Patent Application No. 63/278,991, filed Nov. 12, 2021, entitled “IMAGING LIGHT GUIDE APPARATUS WITH LIGHT SECURITY”; this patent application also claims the priority benefit of U.S. Provisional Patent Application No. 63/524,614, filed Jun. 30, 2023, entitled “IMAGING LIGHT GUIDE APPARATUS WITH LIGHT SECURITY”, each of which is incorporated herein by reference in its entirety for all purposes.

### TECHNICAL FIELD

The present disclosure relates generally to electronic displays and more particularly to displays utilizing image light guides with diffractive optics to convey image-bearing light to a viewer.

### BACKGROUND

Head-Mounted Displays (HMDs) and virtual image near-eye displays are being developed for a range of diverse uses, including military, commercial, industrial, firefighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

Although conventional image light guide arrangements have provided significant reduction in bulk, weight, and overall cost of near-eye display optics, further improvements are needed. In some instances, light is output from a near-eye display in more directions than the direction of the viewer eyebox. However, a number of applications utilizing near-eye displays would benefit from a near-eye display operable to control and/or eliminate light output in undesired directions. For example, a near-eye display having light security may appeal to commercial and general consumers because the near-eye display may appear more like traditional eyewear (i.e., aesthetic improvement), while military applications may benefit from light security for concealment and visibility purposes. Thus, there is a need for an image light guide system operable to produce the desired virtual image brightness and resolution while managing the output of light in undesired directions.

### SUMMARY

In a first exemplary embodiment, the present disclosure provides a light secure image light guide including an image source operable to generate image-bearing light beams and a waveguide operable to propagate the image-bearing light beams. An in-coupling diffractive optic formed along the waveguide, wherein the in-coupling diffractive optic is operable to diffract a portion of the image-bearing light beams from the image source into the waveguide in an angularly encoded form, and an out-coupling diffractive optic formed along the waveguide, wherein the out-coupling diffractive optic is operable to expand the portion of image-bearing light beams, direct a first portion of expanded image-bearing light beams from the waveguide in an angularly decoded form in a first direction toward an eyebox, and direct a second portion of expanded image-bearing light beams from the waveguide in a second direction different from said first direction. The image light guide further including an optical device operable to reduce, eliminate, and/or block the second portion of expanded image-bearing light beams output from the image light guide in the second direction.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 shows a simplified cross-sectional view of an image light guide showing the expansion of an image-bearing beam along the direction of propagation for expanding one direction of an eyebox.

FIG. 2 shows a perspective view of an image light guide with a turning grating showing the expansion of an image-bearing beam perpendicular to the direction of propagation for expanding a second direction of an eyebox.

FIG. 3 shows a schematic side view of an image light guide with a waveguide and a liquid crystal shutter according to an exemplary embodiment of the presently disclosed subject matter.

FIGS. 4A and 4B show a schematic side view of a portion of the liquid crystal shutter according to FIG. 3.

FIGS. 5A, 5B, and 5C show a graph of projector voltage signal to duty cycle according to an exemplary embodiment of the presently disclosed subject matter.

FIG. 6 shows a schematic side view of an image light guide with a waveguide according to an exemplary embodiment of the presently disclosed subject matter.

FIG. 7 shows a schematic side view of a portion of the out-coupling diffractive optic according to FIG. 6.

FIG. 8 shows a schematic side view of a portion of the out-coupling diffractive optic according to FIG. 7.

FIGS. 9A and 9B show graphs of one or more orders of diffraction of light incident upon the out-coupling diffractive optic according to FIG. 8.

FIG. 10A shows a schematic side view of a portion of an out-coupling diffractive optic according to an exemplary embodiment of the presently disclosed subject matter.

FIG. 10B shows a schematic side view of a portion of an in-coupling diffractive optic according to an exemplary embodiment of the presently disclosed subject matter.

FIG. 11 shows a schematic side view of an image light guide with a waveguide and a photonic crystal shield according to an exemplary embodiment of the presently disclosed subject matter.

FIG. 12 shows a portion of the photonic crystal shield according to FIG. 11.

FIGS. 13A and 13B show a schematic perspective view of a near-eye display with an image light guide having an overshield according to an exemplary embodiment of the presently disclosed subject matter.

FIGS. 14A and 14B show a schematic perspective view of a near-eye display with an image light guide having an overshield according to another exemplary embodiment of the presently disclosed subject matter.

FIGS. 14C and 14D show a schematic perspective view of a near-eye display with an image light guide having an overshield according to yet another exemplary embodiment of the presently disclosed subject matter.

FIG. 15 shows a side view of an optical diode according to an exemplary embodiment of the presently disclosed subject matter.

FIG. 16 shows a schematic side view of an image light guide with a waveguide according to an exemplary embodiment of the presently disclosed subject matter.

FIG. 17 shows a schematic side view of the image light guide with a waveguide according to FIG. 16 with an optical diode located at the distal end of the waveguide.

FIG. 18 shows a schematic side view of the image light guide with a waveguide according to FIG. 16 having an optional optical diode positioned between the projector and an in-coupling optic.

FIG. 19A shows a schematic side view of the image light guide with a waveguide according to FIG. 18 having a quarter waveplate located between the optical diode and the in-coupling optic, and a specularly reflective surface located adjacent to the waveguide opposite the projector.

FIG. 19B shows a schematic side view of the image light guide with a waveguide according to FIG. 19A including an optical path of a ray incident upon the specularly reflective surface.

FIG. 20 shows a schematic side view of an image light guide with a waveguide and an electrochromic filter according to an exemplary embodiment of the presently disclosed subject matter.

FIGS. 21A and 21B show a schematic side view of a portion of the electrochromic filter according to FIG. 21.

FIG. 22 shows a schematic side view of an image light guide with a waveguide and multiple electrochromic filters according to an exemplary embodiment of the presently disclosed subject matter.

FIG. 23 shows a schematic side view of an image light guide with a waveguide and a volume hologram according to an exemplary embodiment of the presently disclosed subject matter.

FIG. 24 shows a schematic side view of a portion of the image light guide according to FIG. 23.

FIG. 25 shows a schematic side view of an image light guide with a waveguide and a volume hologram layer according to an exemplary embodiment of the presently disclosed subject matter.

FIG. 26 shows a schematic side view of a portion of the image light guide according to FIG. 25.

FIG. 27A shows a schematic side view of an image light guide with a waveguide and a switchable mirror in a reflective state according to an exemplary embodiment of the presently disclosed subject matter.

FIG. 27B shows a schematic side view of the image light guide according to FIG. 27A with the switchable mirror in a partially reflective state according to an exemplary embodiment of the presently disclosed subject matter.

FIG. 27C shows a schematic side view of the image light guide according to FIG. 27A with the switchable mirror in a transmissive state according to an exemplary embodiment of the presently disclosed subject matter.

FIG. 28 shows a schematic perspective view of a HMD.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, and “user” are considered equivalents and refer to the person, or machine, who wears and/or views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the terms “wavelength band” and “wavelength range” are equivalent and have their standard connotation as used by those skilled in the art of color imaging and refer to a continuous range of light wavelengths that are used to represent polychromatic images.

As used herein, the term “beam expansion” is intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

An optical system, such as a HMD, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a waveguide by an input coupling such as an in-coupling diffractive optic, which can be mounted or formed on a surface of the waveguide or buried within the waveguide. Such diffractive optics can be formed as diffraction gratings, holographic optical elements (HOEs) or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along at least one direction. In addition, a turning optic (e.g., a diffraction grating) can be positioned on/in the waveguide to provide pupil expansion in at least one other direction. The image-bearing light output from the waveguide provides an expanded eyebox for the viewer.

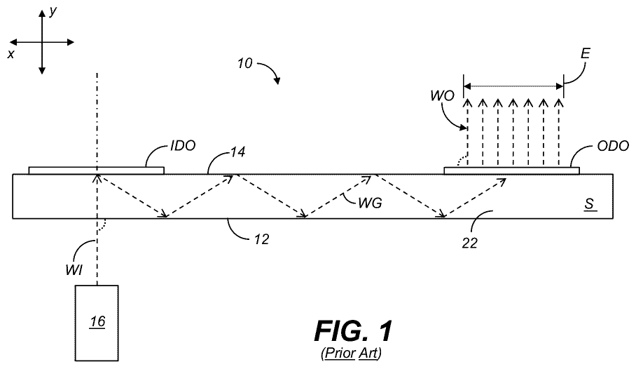

As illustrated in FIG. 1, an image light guide 10 may comprise a planar waveguide 22 having plane-parallel surfaces. The waveguide 22 comprises a transparent substrate S having an outer surface 12 and an inner surface 14 located opposite the outer surface 12. In this example, an in-coupling diffractive optic IDO and an out-coupling diffractive optic ODO are arranged on the inner surface 14 and the in-coupling diffractive optic IDO is a reflective-type diffraction grating through which image-bearing light WI is coupled into the planar waveguide 22. However, the in-coupling diffractive optic IDO could alternately be a volume hologram or other holographic diffraction element, or other type of optical component that provides diffraction for the incoming, image-bearing light WI. The in-coupling diffractive optic IDO can be located on the outer surface 12 or the inner surface 14 of the planar waveguide 22 and can be of a transmissive or reflective type depending upon the direction from which the image-bearing light WI approaches the planar waveguide 22.

When used as a part of a virtual display system, the in-coupling diffractive optic IDO couples the image-bearing light WI from a real image source into the substrate S of the planar waveguide 22. Any real image or image dimension is first converted into an array of overlapping angularly related beams encoding the different pixel positions within an image for presentation to the in-coupling diffractive optic IDO. The image-bearing light WI is diffracted and at least a portion of the image-bearing light WI is thereby redirected by the in-coupling diffractive optic IDO into the planar waveguide 22 as image-bearing light WG for further propagation along the planar waveguide 22 by Total Internal Reflection (“TIR”). Although diffracted into a generally more condensed range of angularly related beams in keeping with the boundaries set by TIR, the image-bearing light WG preserves the image information in an encoded form. The out-coupling diffractive optic ODO receives the encoded image-bearing light WG and diffracts at least a portion of the image-bearing light WG out of the planar waveguide 22 as the image-bearing light WO toward the intended location of a viewer's eye. Generally, the out-coupling diffractive optic ODO is designed symmetrically with respect to the in-coupling diffractive optic IDO to restore the original angular relationships of the image-bearing light WI among outputted angularly related beams of the image-bearing light WO. However, to increase one direction of overlap among the angularly related beams in a so-called eyebox E within which the virtual image can be seen, the out-coupling diffractive optic ODO is arranged to encounter the image-bearing light WG multiple times and to diffract only a portion of the image-bearing light WG on each encounter. The multiple encounters along the length of the out-coupling optic in the direction of propagation have the effect of expanding one direction of the eyebox within which the image-bearing light beams overlap. The expanded eyebox E decreases sensitivity to the position of a viewer's eye for viewing the virtual image.

Out-coupling diffractive optics with refractive index variations along a single direction can expand one direction of the eyebox in their direction of propagation along the waveguide via multiple encounters of the image-bearing light beams with the out-coupling diffractive optic causing replication of the out-coupled image-bearing light beam. In addition, out-coupling diffractive optics with refractive index variations along a second direction can expand a second direction of the eyebox and provide two-directional expansion of the eyebox. The refractive index variations along a first direction of the out-coupling diffractive optic can be arranged to diffract a portion of each beam's energy out of the waveguide upon each encounter therewith through a desired first order of diffraction, while another portion of the beam's energy is preserved for further propagation in its original direction through a zero order of diffraction. The refractive index variations along a second direction of the out-coupling diffractive optic can be arranged to diffract a portion of each beam's energy upon each encounter therewith through a desired first order of diffraction in a direction angled relative to the beam's original direction of propagation, while another portion of the beam's energy is preserved for further propagation in its original direction through a zero order of diffraction.

The out-coupling diffractive optic ODO is shown as a transmissive-type diffraction grating arranged on the inner surface 14 of the planar waveguide 22. However, like the in-coupling diffractive optic IDO, the out-coupling diffractive optic ODO can be located on the outer surface 12 or the inner surface 14 of the planar waveguide 22 and be of a transmissive or reflective type in a combination that depends upon the direction through which the image-bearing light WG is intended to exit the planar waveguide 22.

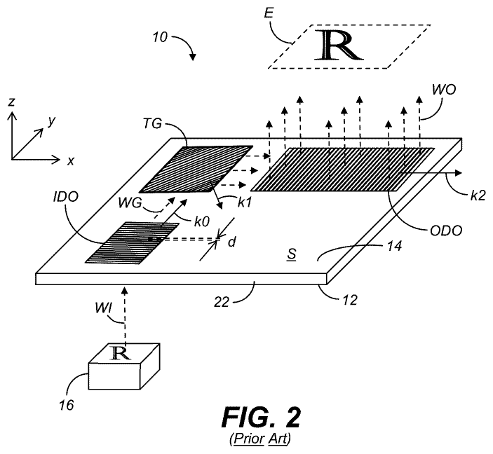

As illustrated in FIG. 2, an image light guide 10 may be arranged for expanding an eyebox E in two directions, i.e., along both x- and y-axes of the intended image. To achieve a second dimension of beam expansion, the in-coupling diffractive optic IDO, having a grating vector k0, is oriented to diffract a portion of the image-bearing light WI toward an intermediate turning grating TG, having a grating vector k1, which is oriented to diffract a portion of the image-bearing light WG in a reflective mode toward the out-coupling diffractive optic ODO. Only a portion of the image-bearing light WG is diffracted by each of multiple encounters with intermediate turning grating TG thereby laterally expanding each of the angularly related beams of the image-bearing light WG approaching the out-coupling diffractive optic ODO. The turning grating TG redirects the image-bearing light WG toward the out-coupling diffractive optic ODO for longitudinally expanding the angularly related beams of the image-bearing light WG in a second dimension before exiting the planar waveguide 22 as the image-bearing light WO. Grating vectors, such as the depicted grating vectors k0, k1, k2, extend in a direction that is normal to the diffractive features (e.g., grooves, lines, or rulings) of the diffractive optics and have a magnitude inverse to the period or pitch d (i.e., the on-center distance between grooves) of the diffractive optics IDO, TG, ODO. The in-coupling diffractive optic IDO, the turning grating TG, and the out-coupling diffractive optic ODO may each have a different period or pitch d.

As illustrated in FIG. 2, the in-coupling diffractive optic IDO receives the incoming image-bearing light WI containing a set of angularly related beams corresponding to individual pixels or equivalent locations within an image generated by an image source 16. The image source 16, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. The image light guide 20 outputs an expanded set of angularly related beams in two dimensions of the image by providing multiple encounters of the image-bearing light WG with both the intermediate turning grating TG and the out-coupling diffractive optic ODO in different orientations. In the original orientation of the planar waveguide 22, the intermediate grating TG provides beam expansion in the y-axis direction, and the out-coupling diffractive optic ODO provides a similar beam expansion in the x-axis direction. The reflectivity characteristics and respective periods d of the diffractive optics IDO, ODO, TG, together with the orientations of their respective grating vectors, provide for beam expansion in two dimensions while preserving the intended relationships among the angularly related beams of the image-bearing light WI that are output from the image light guide 20 as the image-bearing light WO.

While the image-bearing light WI input into the image light guide 20 is encoded into a different set of angularly related beams by the in-coupling diffractive optic IDO, the information required to reconstruct the image is preserved by accounting for the systematic effects of the in-coupling diffractive optic IDO. The turning grating TG, located in an intermediate position between the in-coupling and out-coupling diffractive optics IDO, ODO, is typically arranged so that it does not induce any significant change on the encoding of the image-bearing light WG. In some examples, the combined diffractive effects of in-coupling diffractive optic IDO and the turning grating TG operate to encode image-bearing light WG, while the diffractive effects of the out-coupling diffractive optic ODO operates to decode the combined encoding. The out-coupling diffractive optic ODO is typically arranged in a symmetric fashion with respect to the in-coupling diffractive optic IDO, e.g., including diffractive features sharing the same period. Similarly, the period of the turning grating TG also typically matches the common period of the in-coupling and out-coupling diffractive optics IDO, ODO. As illustrated in FIG. 2, the grating vector k1 of the turning grating TG may be oriented at 45 degrees with respect to the other grating vectors k0, k2 (all as undirected line segments). However, in an embodiment, the grating vector k1 of the turning grating TG is oriented at 60 degrees to the grating vectors k0, k2 of the in-coupling and out-coupling diffractive optics IDO, ODO in such a way that the image-bearing light WG is turned 120 degrees. By orienting the grating vector k1 of the intermediate turning grating TG at 60 degrees with respect to the grating vectors k0, k2 of the in-coupling and out-coupling diffractive optics IDO, ODO, the grating vectors k0, k2 are also oriented at 60 degrees with respect to each other (again considered as undirected line segments). Basing the grating vector magnitudes on the common pitch of the turning grating TG and the in-coupling and out-coupling diffractive optics IDO, ODO, the three grating vectors k0, k1, k2 (as directed line segments) form an equilateral triangle, and sum to a zero-vector magnitude, which avoids asymmetric effects that could introduce unwanted aberrations including chromatic dispersion.

The image-bearing light WI that is diffracted into the planar waveguide 22 is effectively encoded by the in-coupling diffractive optic IDO, whether the in-coupling diffractive optic IDO uses gratings, holograms, prisms, mirrors, or some other mechanism. Any reflection, refraction, and/or diffraction of light that takes place at the in-coupling diffractive optic IDO must be correspondingly decoded by the out-coupling diffractive optic ODO to re-form the virtual image that is presented to the viewer. The turning grating TG, placed at an intermediate position between the in-coupling and out-coupling diffractive optics IDO, ODO, is typically designed and oriented so that it does not induce any change on the encoded light. The out-coupling diffractive optic ODO decodes the image-bearing light WG into its original or desired form of angularly related beams that have been expanded to fill the eyebox E.

Whether any symmetries are maintained or not among the turning grating TG and the in-coupling and out-coupling diffractive optics IDO, ODO or whether any change to the encoding of the angularly related beams of the image-bearing light WI takes place along the planar waveguide 22, the turning grating TG and the in-coupling and out-coupling diffractive optics IDO, ODO are related so that the image-bearing light WO that is output from the planar waveguide 22 preserves or otherwise maintains the original or desired form of the image-bearing light WI for producing the intended virtual image.

The letter “R” represents the orientation of the virtual image that is visible to the viewer whose eye is in the eyebox E. As shown, the orientation of the letter “R” in the represented virtual image matches the orientation of the letter “R” as encoded by the image-bearing light WI. A change in the rotation about the z axis or angular orientation of incoming image-bearing light WI with respect to the x-y plane causes a corresponding symmetric change in rotation or angular orientation of outgoing light from out-coupling diffractive optic ODO. From the aspect of image orientation, the turning grating TG simply acts as a type of optical relay, providing expansion of the angularly encoded beams of the image-bearing light WG along one axis (e.g., along the y-axis) of the image. The out-coupling diffractive optic ODO further expands the angularly encoded beams of the image-bearing light WG along another axis (e.g., along the x-axis) of the image while maintaining the original orientation of the virtual image encoded by the image-bearing light WI. As illustrated in FIG. 2, the turning grating TG may be a slanted or square grating arranged on the front or back surfaces of the planar waveguide 22. Alternately, the turning grating TG may be a blazed grating.

The present disclosure provides for an image light guide arrangement having improved image-bearing light output control. More specifically, the present disclosure provides for, inter alia, an image light guide system and AR display system having means of reducing, eliminating, and/or blocking light output from the image light guide in a direction generally opposite the eyebox.

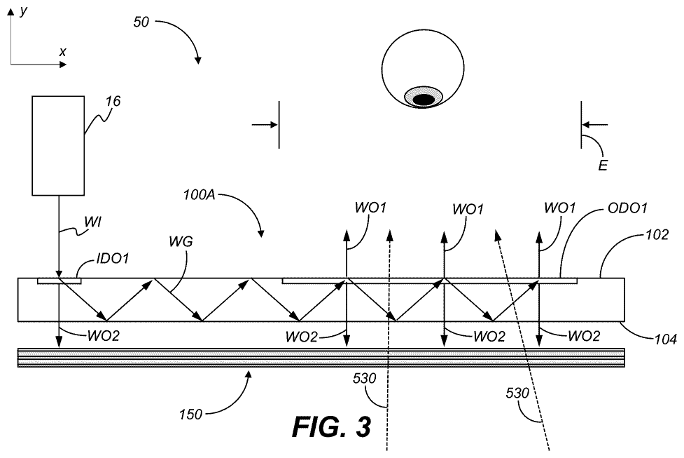

As illustrated in FIG. 3, in an embodiment, an image light guide system 50 includes a planar waveguide 100A having a first surface 102 and a second surface 104. The waveguide first surface 102 is positioned generally parallel with the waveguide second surface 104. A first in-coupling diffractive optic IDO1 and a first out-coupling diffractive optic ODO1 are formed on/in the first surface 102. In an embodiment, the waveguide 100A includes additional diffractive optics, such as a second in-coupling diffractive optic, an intermediate diffractive optic (e.g., turning grating), and/or a second out-coupling diffractive optic. The first out-coupling diffractive optic ODO1 may comprise a compound diffractive optic. In an embodiment, the image source 16 is a color field sequential projector system operable to pulse image-bearing light of red, green and blue wavelength ranges onto a digital light modulator/micro-mirror array (a “DLP”) or a liquid crystal on silicon (“LCOS”) display. The image source 16 may be operable to operate in a low light mode using image-bearing light of only one of the red, green and blue wavelength ranges. For example, in the low light mode, the image source 16 may emit image-bearing light for approximately 33%, or less, of the time the image source 16 is “on.” In another example embodiment, the image source 16 is three independent picoprojectors, each picoprojector operable to emit light of a different wavelength range. In some embodiments, all three wavelength ranges can be energized at the same time.

Image-bearing light WI from the image source 16 is incident upon the first in-coupling diffractive optic IDO1 and at least a portion of the image-bearing light WI is diffracted by the first in-coupling diffractive optic IDO1 and generally propagates toward the out-coupling diffractive optic ODO1 via TIR as image-bearing light WG. At least a portion of the image-bearing light WG incident upon the out-coupling diffractive optic ODO1 may be expanded in at least one direction and may be directed out of the first planar waveguide 100A by the out-coupling diffractive optic ODO1 as out-coupled image-bearing light beams WO1, WO2 (representing central rays of out-coupled image-bearing light beams). The first out-coupled image-bearing light beams WO1 are emitted in a first direction toward the eyebox E where the viewer's eye is operable to view a virtual image. The second out-coupled image-bearing light beams WO2 are emitted in a second direction opposite the eyebox E.

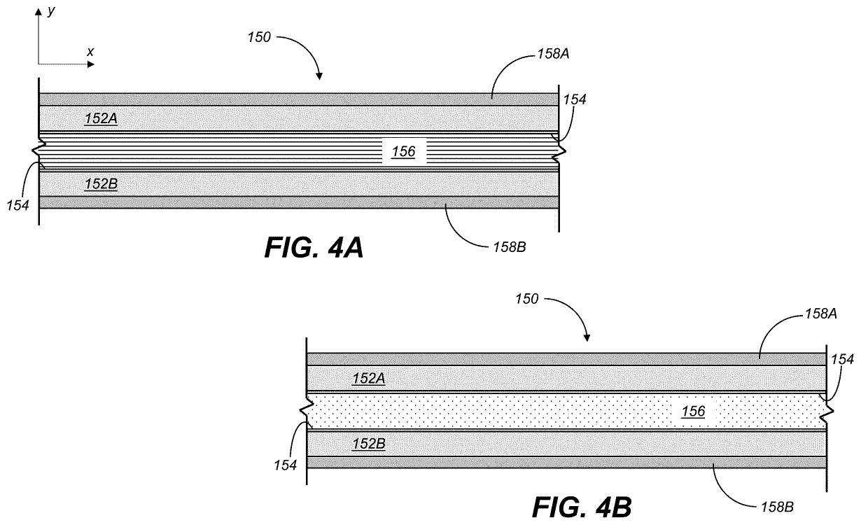

Referring now to FIGS. 3, 4A and 4B, in an embodiment, the image light guide system 50 includes an optical device comprising a liquid crystal shutter 150. In some example embodiments, the liquid crystal shutter 150 may include first and second glass substrates 152A, 152B coated with a transparent conductive material 154 on the inner surfaces, respectively, thereof such that an electric field can be created between the first and second glass substrates 152A, 152B. When the electric field is ON, a liquid crystal 156 (“LC”) located between the first and second glass substrates 152A, 152B aligns in a first direction as shown in FIG. 4A, and when the electric field is OFF, the LC 156 aligns in a second, different, direction as shown in FIG. 4B. The liquid crystal shutter 150 may also include first and second polarizing films 158A, 158B located on the outer surfaces, respectively, of the first and second glass substrates 152A, 152B. The polarizing films 158A, 158B, for example, may have polarization axes generally crossed relative to one another.

The LC 156 is operable to turn the polarization direction of the image-bearing light WO2 similar in effect to a waveplate. For example, the LC 156 may be operable to rotate the polarization of the polarized light from 158A through 90 degrees. When the electric field is ON, the second out-coupled image-bearing light WO2 incident upon the liquid crystal shutter 150 in a first linear polarization state is absorbed. When the electric field is in an OFF state, the second out-coupled image-bearing light WO2 transmitted by the LC 156 is transmitted by the second polarizing film 158B.

In an embodiment, the first polarizing film 158A is replaced by a waveplate and the waveguide 100A utilizes polarized gratings. It should be appreciated that the foregoing example configuration of the liquid crystal shutter 150 is not intended to be limiting and is merely one potential example configuration. Those with ordinary skill in the art would appreciate that other configurations are possible.

The liquid crystal shutter 150 may block approximately 50% of ambient light incident thereon due to the absorptive nature of the first and second polarizers 158A, 158B. Where, for example, the image source 16 operates at a frame rate of approximately 60 Hz, pixels of a particular wavelength range are displayed for some portion of the frame rate. When, for example, the image source 16 operates at a duty cycle where the frame rate is one-sixtieth ( 1/60^{th}) of a second, the duty cycle would be one-third (⅓) of the frame rate or less.

Therefore, the image source 16 emits image-bearing light WI of at least one of the red, green, and blue wavelength ranges for less than half (<½) of the frame rate of the image source 16. The liquid crystal shutter 150 is operable to reduce transmission of the second out-coupled image-bearing light WO2 to nearly nothing for the period in which the image source 16 is emitting image-bearing light WI. In an embodiment, the liquid crystal shutter 150 is configured to operate fully dark for the period of time the image source 16 emits image-bearing light in the low light mode.

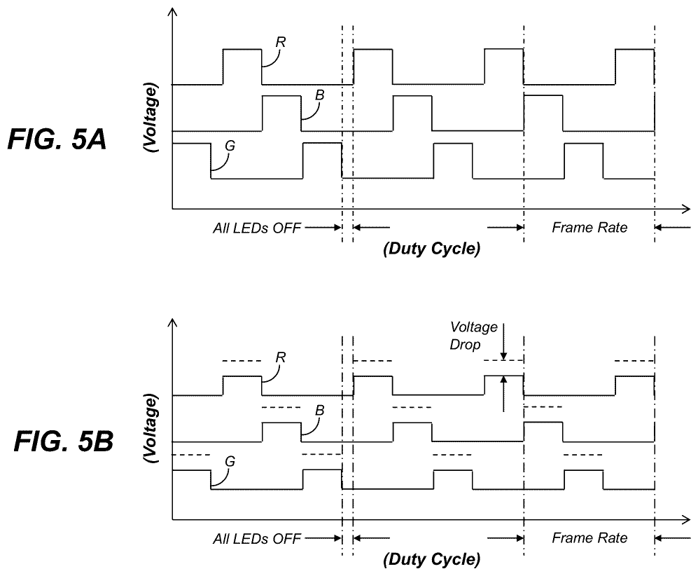

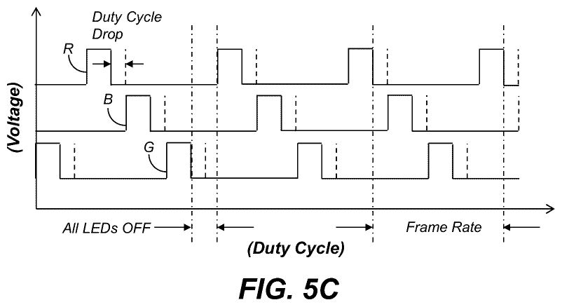

In an embodiment, the liquid crystal shutter 150 is configured to block the red wavelength range of light, while generally permitting the green and blue wavelength ranges of light to be transmitted therethrough. For example, the image source 16 may be operable to emit image-bearing light WI of a first wavelength range and the first polarizer 158A is limited to the first wavelength range. In this embodiment, the transmission of ambient light by the liquid crystal shutter 150 is increased to approximately 75% (e.g., absorption is reduced from approximately 50% to one-third of 50%). In other words, utilizing the liquid crystal shutter 150 to block only one wavelength range of light changes the time that the liquid crystal shutter 150 needs to be in an ON state. Therefore, the ON/OFF timing is different compared to when trying to block all color wavelength ranges. In an embodiment, the programmable image source 16 includes a mode of operation in which only the red wavelength range is emitted, and the liquid crystal shutter 150 is only ON for the red wavelength range of light R part of the frame rate shown in FIG. 5A.

In an example embodiment, the liquid crystal shutter 150 may block approximately 50% of ambient light incident thereon due to the absorptive nature of the first and second polarizers 158A, 158B. Where, for example, the image source 16 operates at a frame rate of approximately 120 Hz, pixels of each wavelength range are displayed at the same time for some portion of the frame rate (e.g., approximately 5%). For example, pixels of each wavelength range may emit for approximately 5% of the frame rate at approximately ten times (10×) the power, resulting in an approximately 45% effective transmission of ambient light through the liquid crystal shutter 150. In an example, pixels of each wavelength range may emit for approximately 5-10% of the frame rate at approximately ten times (10×) the power, resulting in an approximately 40-45% effective transmission of ambient light through the liquid crystal shutter 150.

In examples that utilize a 33% duty cycle, the liquid crystal shutter 150 must be actively blocking transmission of ambient light 33% of the frame rate. This reduces the native effective transmission of the ambient light through the system to approximately 17%. For comparison, conventional sunglasses allow for transmission of ambient light between 10-15%. Thus, a system only requiring the liquid crystal shutter 150 to actively block transmission of ambient light for 5% of the frame rate (with an effective overall transmission of ambient light of 45%) is advantageous over systems utilizing a 33% duty cycle because the transmission rates are substantially higher than conventional sunglasses while still providing light security.

In example embodiments, forward emitted light is limited to approximately 1/10th of the light emitted towards the eye. Further, example μLED image source systems operate at faster frame rates than conventional image source solutions. This is advantageous because these μLED image source systems are efficient and fast enough to support a duty cycle where the display is off the majority of the individual frame rate. A compact shutter, as described herein, can be incorporated to block light only during the portion of the duty cycle when the μLED image source system is illuminating. The majority of the time the system will be largely transparent, with the switching speeds being at 120 Hz or less and not visible to the user. Light emitted from the system would not be visible from a distance.

For situations requiring full brightness from the system, and having less stringent light security requirements, the system can be flipped up out of the way or removed entirely. Alternatively, for very low light situations, for example overcast starlight, where attenuation of the visible light must be absolutely minimized, it may be preferred to switch to a notch filter that prevents a limited wavelength range from being transmitted. In such a system a red filter combined with a monochrome red image may supply the best overall user experience.

Referring now to FIGS. 5A, 5B, and 5C, in an embodiment, the brightness of the first and second out-coupled image-bearing light WO1, WO2 can be adjusted by changing a voltage of the image source 16 and/or by changing the duty cycle (i.e., the amount of time per frame a red, green, and/or blue wavelength range of light R, G, B is ON). For example, as illustrated in FIG. 5B, the brightness of the first and second out-coupled image-bearing light WO1, WO2 can be decreased by reducing the magnitude of the voltage to the LEDs for each wavelength range of light R, G, B in the image source 16. Similarly, as illustrated in FIG. 5C, the brightness of the first and second out-coupled image-bearing light WO1, WO2 can be decreased by reducing the duty cycle of the LEDs for each wavelength range of light R, G, B in the image source 16.

In an embodiment, the liquid crystal shutter 150 may comprise a Polymer Dispersed Liquid Crystal (PDLC) adhesive smart film such as that developed by Gauzy Ltd., having a place of business at 14 Hathiya Street, Tel Aviv-Yafo, Israel 6816914. For example, the smart film is generally 560 μm thick and operates at a switching time of 10 ms.

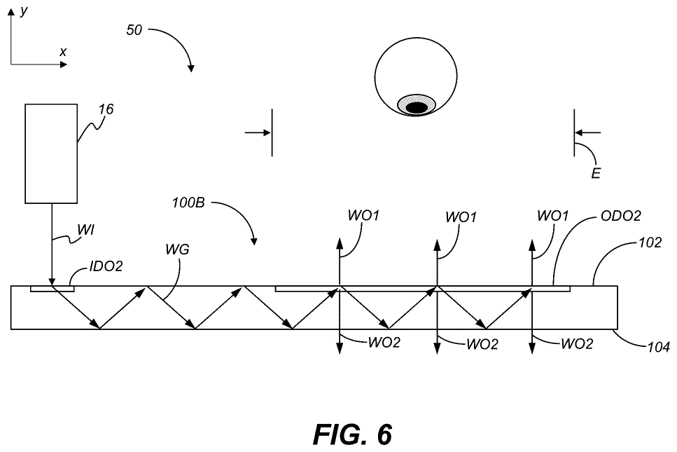

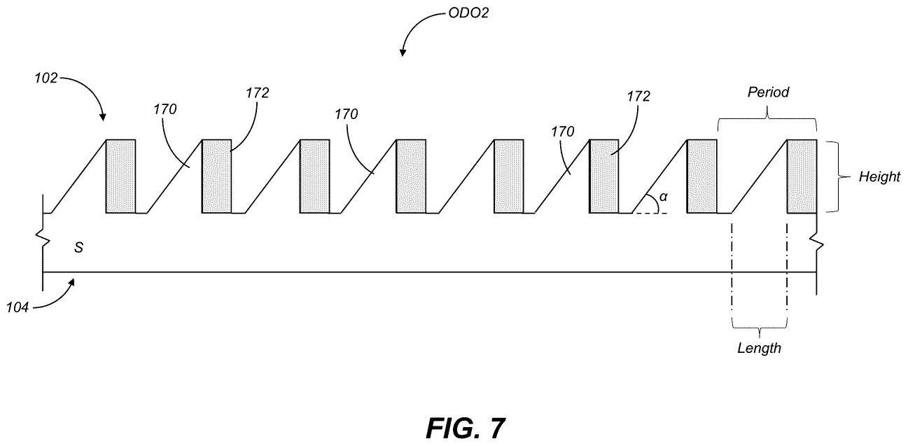

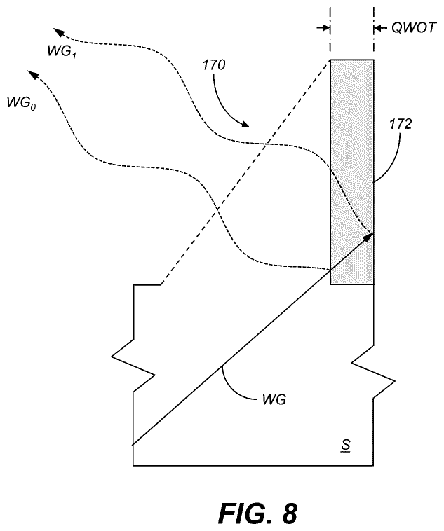

In an embodiment, as illustrated in FIG. 6, the image light guide system 50 includes a planar waveguide 100B having at least an in-coupling diffractive optic IDO2 and an out-coupling diffractive optic ODO1 formed on/in the first surface 102. As illustrated in FIGS. 7 and 8, in an embodiment, the out-coupling diffractive optic ODO2 includes diffractive features 170 forming a blazed grating. The diffractive features 170 of a blazed grating each form a right triangle with a blaze angle α. The blaze angle α may be utilized to optimize the diffractive efficiency of the out-coupling diffractive optic ODO2 for a given wavelength range of light. In an embodiment, the blazed diffractive features 170 each form a triangle with a blaze angle α. In an embodiment, one or more surfaces of the blazed diffractive features 170 may be curved.

In an embodiment, an anti-reflective coating 172 is located on the generally vertical surface of each blazed diffractive feature 170. The anti-reflective coating 172 having a thickness of one-quarter (¼) of one of the wavelengths of the image-bearing light WG when the image-bearing light WG is within the anti-reflective coating 172, also referred to as a quarter wavelength of thickness. In one embodiment, the refractive index of the anti-reflective coating 172 can be calculated by taking the geometric mean of the index of refraction of the waveguide substrate S (which is generally the same for the diffractive features 170) and the index of refraction of the surrounding substance (e.g., air):

$${n}_{C} = √ {n}_{A} \cdot {n}_{S}$$

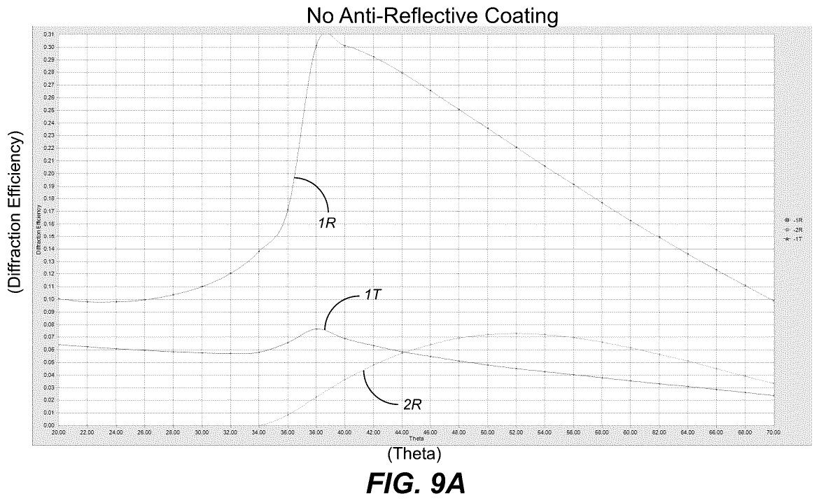

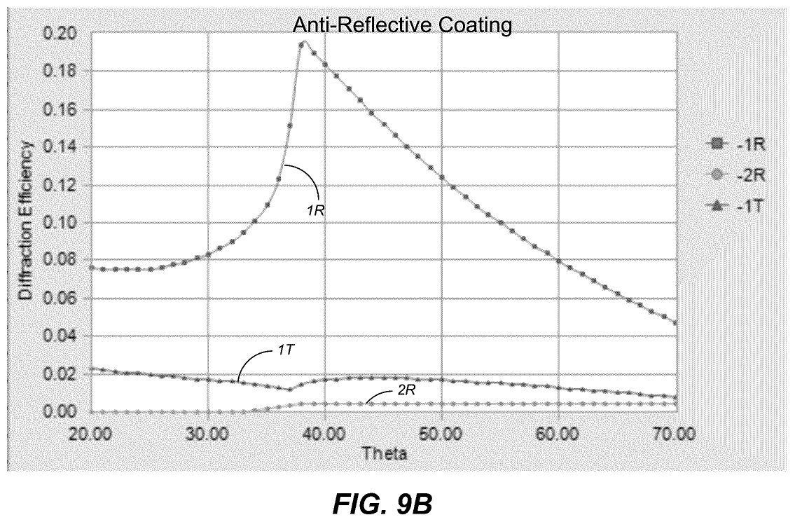

For example, where the refractive index ns of the substrate S is 1.65 and the blazed grating features 170 are exposed to air having a refractive index n_{A}=1.0, the refractive index of the anti-reflective coating 172 is n_{C}=1.28. However, persons skilled in the relevant arts will recognize that the refractive index of the anti-reflective coating 172 can also be calculated in other ways. As illustrated in FIG. 8 and shown in the graphs of FIGS. 9A and 9B, the anti-reflective coating 172 is operable to destroy, via destructive interference, a portion of the image-bearing light WG incident upon the out-coupling diffractive optic ODO2 which would otherwise be propagated as second-order diffracted light and output in a direction opposite the eyebox E. Because the out-coupling diffractive optic ODO2 is formed with the blazed grating, the first-order diffracted light is not out-coupled in a direction opposite the eyebox E. Therefore, the design of the planar waveguide 100B reduces or eliminates the second out-coupled image-bearing light beams WO2.

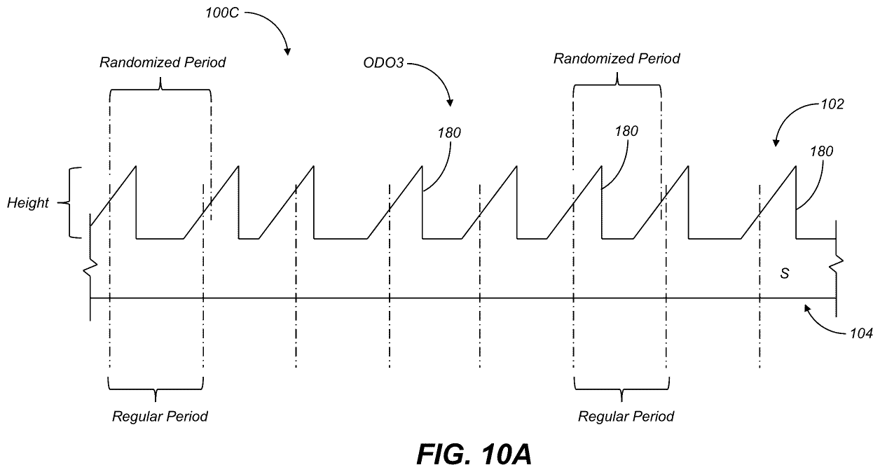

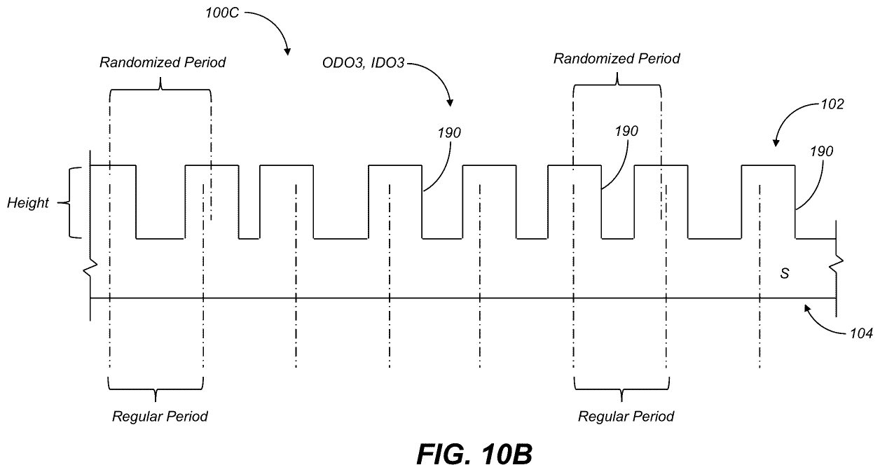

In an embodiment, as illustrated in FIG. 10A, the image light guide system 50 includes a planar waveguide 100C having an out-coupling diffractive optic ODO3 formed on/in the first surface 102. The out-coupling diffractive optic ODO3 includes blazed diffractive features 180 that are randomly or pseudo randomly (collectively referred to herein as “randomly” or “random”) displaced over a distribution. In an embodiment, as illustrated in FIG. 10B, the out-coupling diffractive optic ODO3 is a linear diffractive grating with approximately rectangular features 190 randomly displaced over a distribution. The period of the diffractive features 180, 190 are randomized according to a cosine probability distribution:

$$ρ ( s ) = - π / D cos ( 2 π s / D ) rect ( ( 2 s / D ) - 1 )$$

By randomizing the period of the diffractive features 180, 190 according to a cosine probability distribution, the second-order diffraction of the image-bearing light WG incident upon the out-coupling diffractive optic ODO3 is reduced or eliminated, thereby reducing and/or eliminating the second out-coupled image-bearing light beams WO2 normally output by the out-coupling diffractive optic ODO3 in a direction opposite the eyebox E.

As described in Nan Gao and Changqing Xie, High-Order Diffraction Suppression Using Modulated Groove Position Gratings, Optics Letters, Vol. 36, No. 21 (Nov. 1, 2011), incorporated herein by reference in its entirety, randomly varying the position of the diffractive features 180, 190 a small amount suppresses the second order of diffraction. In addition, image-bearing light in the first order of diffraction is increased in intensity and is not out-coupled in a direction opposite the eyebox E where the out-coupling diffractive optic ODO1 is formed with a blazed grating. In an embodiment, as illustrated in FIG. 10B, the period of linear diffractive features 190 of the in-coupling diffractive optic IDO3 is randomized according to a cosine probability distribution such that the second-order diffraction of the image-bearing light WG incident upon the in-coupling diffractive optic IDO3 is reduced or eliminated.

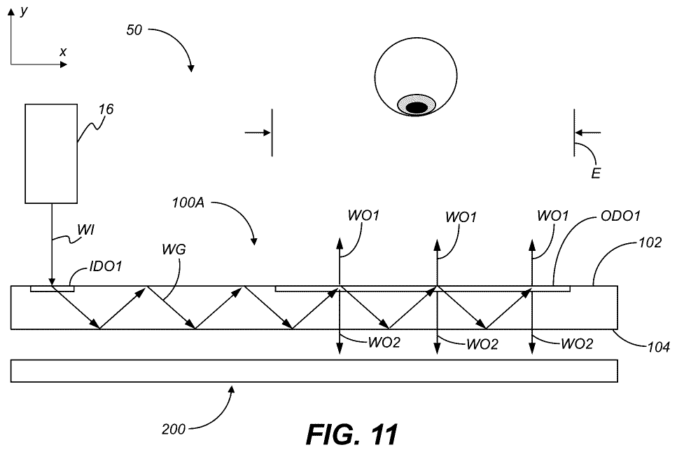

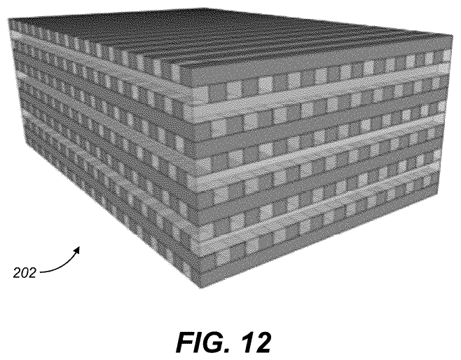

In an embodiment, as illustrated in FIG. 11, the image light guide system 50 having the planar waveguide 100A including the in-coupling diffractive optic IDO1 and the out-coupling diffractive optic ODO1 formed on/in the first surface 102 includes an optical device comprising a photonic crystal shield 200. In an embodiment, the photonic crystal shield 200 is a fixed layer of the image light guide system 50. The photonic crystal shield 200 includes a three-dimensional photonic crystal 202 having periodic index of refraction variation in three axes. The periodic variation in three axes provides the three-dimensional photonic crystal 202 with a complete photonic band gap enabling complex light emission control. As illustrated in FIG. 12, in an embodiment, the three-dimensional photonic crystal 202 is of the woodpile construct comprising silicon nitride with an interstitial material of nano-porous silicon dioxide. In an embodiment, the projector 16 comprises LEDs operable to emit a wavelength range, such as red light. The photonic crystal shield 200 is operable to reflect light in at least one of, or a portion of, the wavelength range of the projector LEDs. Correspondingly, light in the wavelength range of the projector LEDs incident upon the photonic crystal shield 200 from the environment is reflected before reaching the waveguide 100A.

In an embodiment, the photonic crystal shield 200 is configured to block a first wavelength range of light, while generally permitting second and third wavelength ranges of light to be transmitted therethrough. For example, the programmable image source 16 may be operable to emit only image-bearing light WI of a first wavelength range and the photonic crystal shield 200 is configured to block the first wavelength range while generally permitting second and third wavelength ranges of light to be transmitted therethrough.

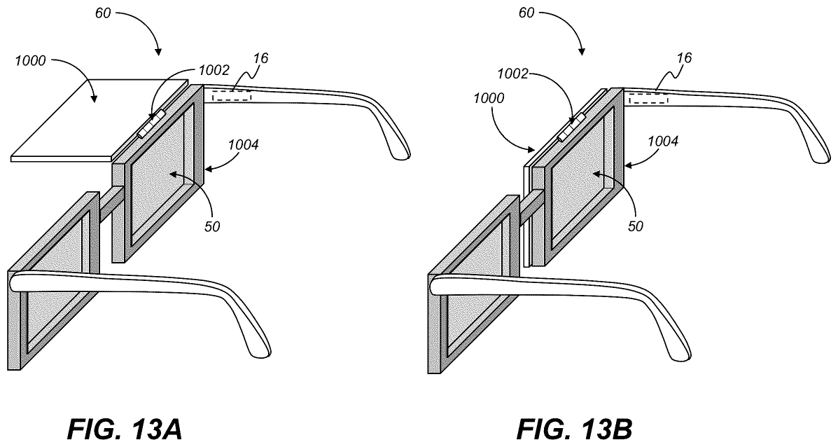

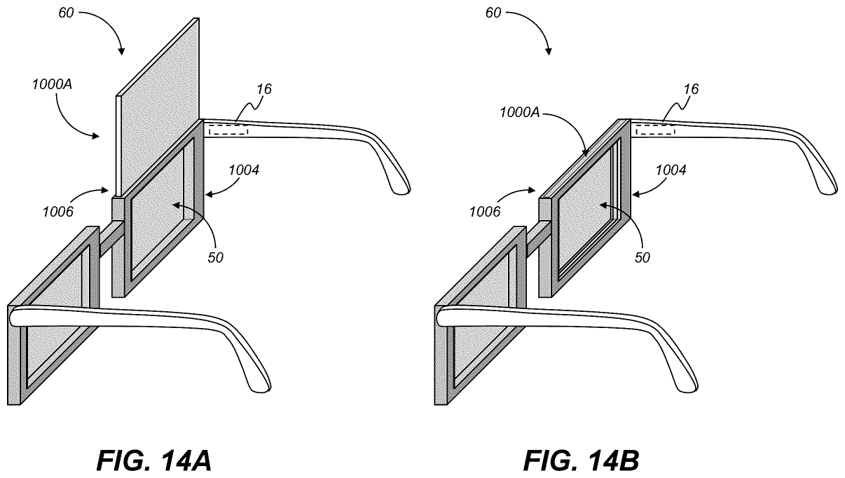

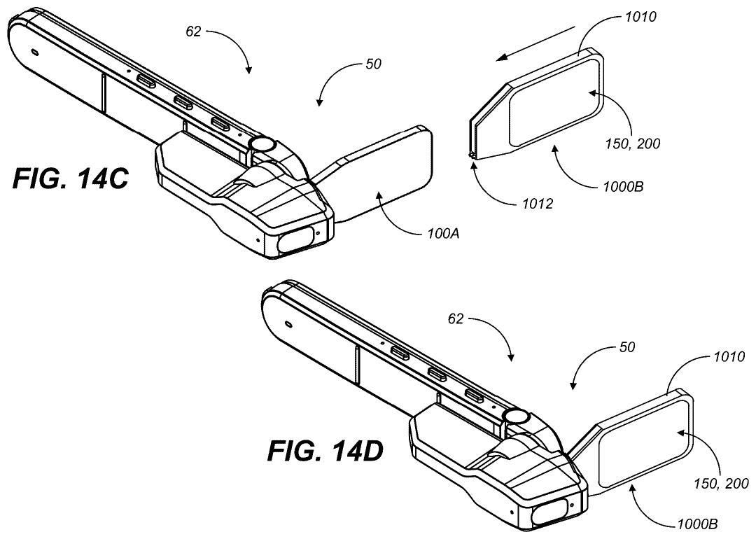

Referring now to FIGS. 13A-14B, the liquid crystal shutter 150 or the photonic crystal shield 200 may be embodied in an overshield 1000 operable to translate in and out of the path of light from the environment through the image light guide system 50. As illustrated in FIGS. 13A and 13B, in an embodiment, the liquid crystal shutter 150 or the photonic crystal shield 200 is coupled with the frame of a near-eye display 60 via a hinge 1002. For example, the hinge 1002 may be coupled with an eye-piece rim 1004 to enable rotation of the liquid crystal shutter 150 or the photonic crystal shield 200 around the longitudinal axis of the hinge 1002 relative to the planar waveguide 100A. Additionally, any of the optical devices 150, 200, 400, 800, 900, 1100 operable to reduce a portion of expanded image-bearing light beams output from the image light guide in a direction opposite the eyebox as described intra may be embodied in the overshield 1000.

As illustrated in FIGS. 14A and 14B, any of the optical devices described herein, e.g., the liquid crystal shutter 150, the photonic crystal shield 200, the optical diode 400, the electrochromic filter 800, the volume hologram 900, the electro-optically switchable mirror 1100, or any combination thereof may be embodied in an overshield 1000A slidably coupled with the frame of a near-eye display 60 via a slot 1006 in the eye-piece rim 1004. For example, the slot 1006 may enable the liquid crystal shutter 150 or the photonic crystal shield 200 to translate relative to the planar waveguide 100A and in and out of the path of light from the environment through the image light guide system 50.

As illustrated in FIGS. 14C and 14D, the liquid crystal shutter 150 or the photonic crystal shield 200 may be embodied in an overshield 1000B slidably coupled with a portion of the frame of a monocular near-eye display 62. The overshield 1000B may include a sleeve 1010 operable to cover at least a portion of the waveguide 100A of the image light guide system 50. The sleeve 1010 may include electrical contacts 1012 located at an end of the sleeve 1010 and operable to connect with a power source of the monocular near-eye display 62 to supply a voltage to the liquid crystal shutter 150, the photonic crystal shield 200, or the switchable mirror 1100.

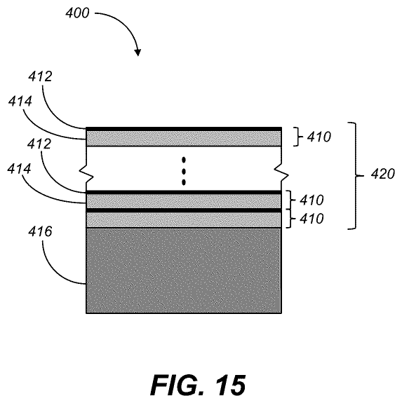

As illustrated in FIG. 15-17, in an embodiment, the image light guide system 500 having the planar waveguide 504 including at least the in-coupling diffractive optic 506 and the out-coupling diffractive optic 508 formed on/in the first surface 510, includes the optical device 400 comprising an optical diode, also referred to herein as an optical isolator. The optical diode 400 may be constructed by stacking multiple component layers 410 comprising a plasmonic material 412 with low optical loss and a dielectric material 414. The article B. Janaszek, et al., Nonlocality-Enabled Magnetic Free Optical Isolation in Hyperbolic Metamaterials, Materials 2021, 14, 2865 is incorporated herein by reference in its entirety. Multiple layers 420 of the component layers 410 may be fabricated onto an optical diode substrate 416. In one embodiment, the optical diode 400 includes ten of the component layers 410. In another embodiment, the optical diode 400 includes fewer than ten of the component layers 410, and in yet another embodiment, the optical diode 400 includes greater than ten component layers 410. In one embodiment, the plasmonic material 412 is graphene. In an embodiment, the plasmonic material 412 is a monolayer of graphene, the dielectric material 414 is silicon nitride, and the optical diode substrate 416 is Zinc Selenide (ZnSe). In another embodiment, the optical diode substrate 416 may be another high index transparent optical material, e.g., a glass or polymer material.

In an embodiment, the thickness of the plasmonic material 412 is the same for each component layer 410 of the optical diode 400. In another embodiment, the thickness of the plasmonic material 412 may not be the same in all component layers 410. In an embodiment, the thickness of the dielectric material 414 is the same for each component layer 410 of the optical diode 400. In another embodiment, the thickness of the dielectric material 414 may not all be the same thickness.

In one embodiment, plasmonic material 412 is the same for each component layer 410 of optical diode 400. In another embodiment the plasmonic material 412 is not the same for each component layer 410 of optical diode 400.

In one embodiment, the dielectric material 414 is the same material for each component layer 410 of optical diode 400. In another embodiment the dielectric material 414 is not the same material for each component layer 410 of optical diode 400.

In some examples, the chemical potential of each component layer 410 can be altered to change the permittivity of the optical diode 400. In one example, chemical doping of the component layers 410 causes a change in chemical potential of the component layers 410 which results in a change of the permittivity of each respective component layer 410. In other examples, an electrical voltage is applied across one or more component layers 410 during operation to alter the chemical potential each respective component layer 410, resulting in a change in permittivity. In example embodiments where the plasmonic material 412 is graphene, the graphene layers may be electrically connected to a thin-film-transistor TFT, having one or more electrically addressable portions. When an electric current or voltage is applied across the one or more electrically addressable portions of the TFT, a corresponding portion of the connected graphene layer will experience a change in chemical potential and thus a change in the permittivity of that respective portion. In some examples, the permittivity of the individual component layers 410 of graphene may be altered across the entire layer or only a limited number of portions of the layer. For example, the permittivity of one or more portions of the graphene layer that are coaxially aligned about an imaginary axis passing through the eyebox and the planar waveguide 504 can be altered to prevent transmission of the second out-coupled image-bearing light beams WO2. In some examples the electrical voltage applied across one or more portions of one or more graphene layers is between 0 and 1 eV.

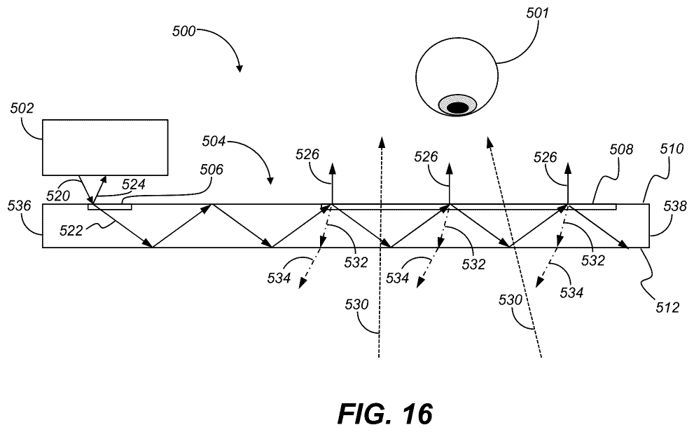

FIG. 16 shows a portion of an image light guide system 500 operable in a head mounted augmented reality (AR) display system. The image light guide system 500 including a micro projector 502 and the parallel plate waveguide 504. A wearer of the system 500 may observe a virtual image via image-bearing light beams from the system 500 entering the wearer's eye 501. The parallel plate waveguide 504 includes plane parallel flat surfaces 510, 512. The parallel plate waveguide 504 also includes an in-coupling diffractive optic 506 and an out-coupling diffractive optic 508. The in-coupling diffractive optic 506 may be a diffractive grating, holographic optical elements, or the like, which optically couples incident image-bearing light beams 520 from the projector 502 into the parallel plate waveguide 504. Generally, when a light beam 520 is incident onto a diffraction grating 506 there will be both one or more reflected beams 524 and one or more transmitted beams 522. Some transmitted beams 522 of particular diffraction orders (e.g., +1 diffraction order) will have angles of incidence to waveguide surface 512 that satisfy the total internal reflection (TIR) condition and will thus reflect off of the surface 512. Similarly, beam 522 after reflecting at surface 512 will satisfy the TIR condition for reflection at the waveguide surface 510. Thus, the in-coupled beam 522 will propagate through the parallel plate waveguide 504 by TIR from the proximal end 536 to the distal end 538 of the waveguide 504.

The parallel plate waveguide 504 further includes an out-coupling diffractive optic 508. Out-coupling diffractive optic 508 may be a diffractive grating, or holographic optical elements, or the like, which optically out-couples at least a portion of the in-coupled beams 522 out of the parallel plate waveguide 504, to become beams 526, typically toward a wearer's eye 501. A portion of the in-coupled beams 522 is reflected back from the out-coupling optic 508 to become reflected beams 532. Some of the reflected beams 532 will no longer meet the requirement for TIR at the waveguide surface 512 and will refract out of the parallel plate waveguide 504 to become beams 534.

When a person is observing someone wearing the image light guide system 500, beams 534 may be visible to the observer. This may compromise the person wearing the image light guide system 500 or compromise the information the wearer is viewing. Additionally, such beams 534 that exit the parallel plate waveguide away from the wearer are cosmetically undesirable. It is therefore desirable to reduce or eliminate beams 534 from being observed.

FIG. 16 further illustrates incident light beams or rays 530 from the environment. A portion of such environment rays 530 pass through the parallel plate waveguide 504 and out-coupling optic 508 to be observed by the wearer's eye 501.

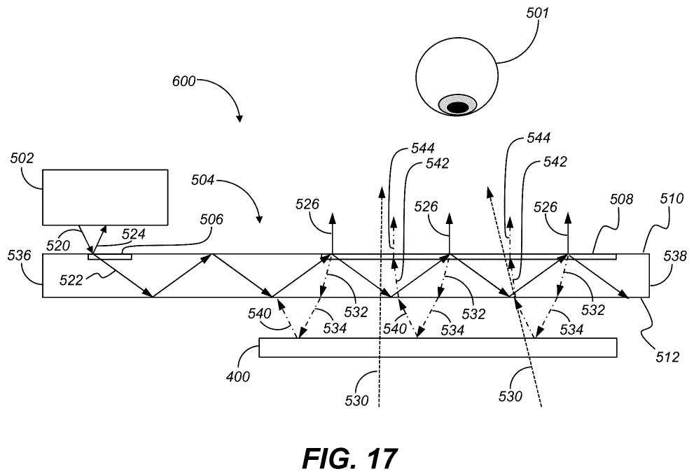

FIG. 17 shows a portion of an image light guide system 600, as detailed in FIG. 16, having an optical diode 400 oriented to reflect beams 534 exiting the parallel plate waveguide 504 through the waveguide surface 512. Optical diode 400 may be constructed as described above, and/or as shown in FIG. 15. The alignment of the optical diode 400 is parallel to the waveguide surface 512. The optical diode 400 may cover the same area as out-coupling diffractive optic 508. In another embodiment, the area of the optical diode 400 covers the area of the out-coupling diffractive optic 508 plus another portion of the waveguide surface 512. In another embodiment, the area of the optical diode 400 covers the entire area of the waveguide surface 512.

In one embodiment, the space between the optical diode 400 and surface 512 is filled with air. In another embodiment, the space between the optical diode 400 and surface 512 forms a closed cavity and is filled with a fluid such as, but not limited to, dry air, air, gaseous argon, or gaseous nitrogen. In yet another embodiment, the space between the optical diode 400 and the waveguide surface 512 is filled with a material having a low index of refraction, such as those materials offered by PiBond Oy, having a place of business at Kutojantie 2, 02630 Espoo, Finland. The material having a low index of refraction may be based on siloxane materials to yield a material which has a refractive index as low as 1.25.

The optical diode 400 is oriented with respect to the parallel plate waveguide 504 such that beams 534 exiting the parallel plate waveguide 504 through the waveguide surface 512 are reflected back toward the parallel plate waveguide 504 as reflected beams 540. A portion of the reflected beams 540 may re-enter the parallel plate waveguide 504 as beams 542. A portion of the beams 542 may encounter the out-coupling diffractive optic 508 and exit the parallel plate waveguide 504 as beams 544. The beams 544 will be essentially parallel to the beams 526 out-coupled by the out-coupling diffractive optic 508. The degree to which the beams 544 are parallel to beams 526 depends, at least in part, on the degree to which the optical diode 400 can be made parallel to the waveguide surface 512 of the parallel plate waveguide 504. The alignment of the optical diode 400 to the waveguide surface 512 is such that the wearer observing the virtual image sees only one image. Misalignment of the optical diode 400 may cause double images to be observed by the wearer.

When the optical diode 400 is properly aligned, beams 544 will strengthen the intensity (i.e., brighten) of the total light emitted from the waveguide 504 toward the wearer's eye 501. With the addition of the out-coupled beams 544 to the out-coupled beams 526, the virtual image that the wearer observes will be brighter than it would be without the optical diode 400. With the optical diode 400 in place and producing a brighter virtual image, the projector 502 may be reduced in power. That is, the amount of light produced by the projector 502 may be reduced to accomplish the same level of observed brightness of the virtual image as without the optical diode 400 in place. Thus, the system 600 may require less electrical power to drive the projector 502, and thus may increase battery lifetime per battery charge. Additionally, with less electrical power required, the system 600 may have reduced heating issues. Thus, there are advantages beyond security for a head mounted AR system having an optical diode 400 constructed and positioned as disclosed herein.

As shown in FIG. 17, the environment light rays 530 pass through the optical diode 400 to allow the wearer a view of the real world approximating the real world view without the optical diode 400 in place.

In an embodiment, the optical diode 400 is configured to block a first wavelength range of light, while generally permitting other wavelength ranges of light to be transmitted therethrough. For example, the image source 502 may be operable to emit image-bearing light 520 in a first wavelength range and the optical diode 400 is configured to block/reflect the first wavelength range.

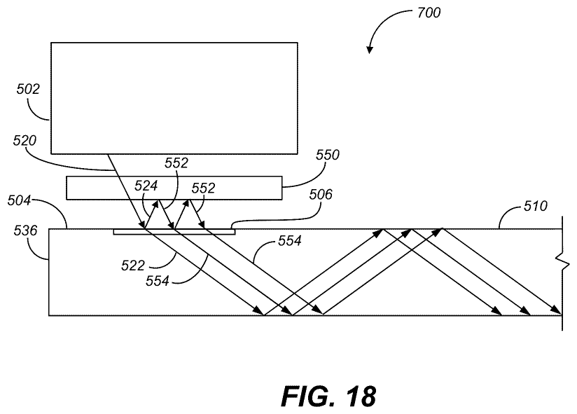

FIG. 18 shows a portion of an image light guide system 700 operable in a head mounted AR display system having one or more features and/or components previously described with regard to systems 500, 600 of FIG. 16 or FIG. 17. Correspondingly, like elements are commonly referred to with like reference numerals. As illustrated in FIG. 18, the image light guide system 700 includes an optical diode 550 positioned optically between the projector 502 and the in-coupling diffractive optic 506 on the waveguide surface 510 of the parallel plate waveguide 504. The optical diode 550 is oriented such that the beam 520 from the projector 502 passes through optical diode 550 and incident on the in-coupling diffractive optic 506. At the in-coupling optic 506, the incident beam 520 will in part be reflected to become beam 524 (which may be one or more diffraction orders, not shown) and will in part be transmitted through the in-coupling optic 506 to become in-coupled beams 522 (which may be one or more diffraction orders, not shown). The optical diode 550 is orientated such that the reflected beams 524 are reflected from optical diode 550. Thus, a portion of the beams 524 are reflected back toward the waveguide 504 as beams 552. A portion of the beams 552 may be incident upon the in-coupling optic 506 and may then become in-coupled beams 554. The in-coupled beams 554 would not propagate in the waveguide 504 in the absence of the optical diode 550. Thus, the optical diode 550 provides for additional beams 554 to couple into the waveguide 504 which subsequently out-couple with beams 522 resulting in a brighter image observed by the wearer of the image light guide system 700. Thus, the benefits of brighter virtual images, reduced battery demands, reduced heat production, may be accomplished by the introduction of the optical diode 550.

The optical diode 550 is positioned such that it is parallel with the waveguide surface 510. In one embodiment, the optical diode 550 is fabricated onto the waveguide surface 510. In another embodiment optical diode 550 is mechanically in contact with surface 510. The alignment of the optical diode 550 is such that multiple images are not produced and seen by the wearer.

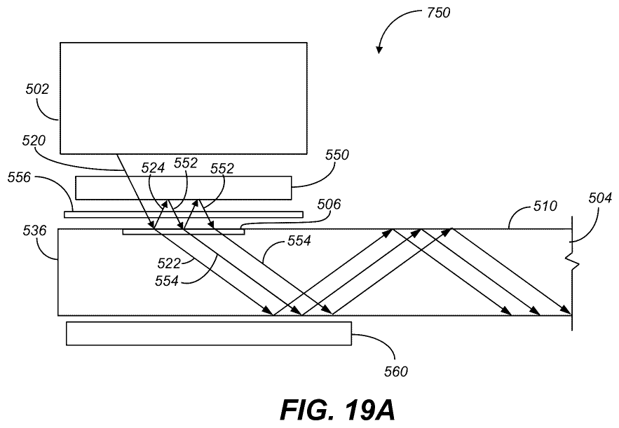

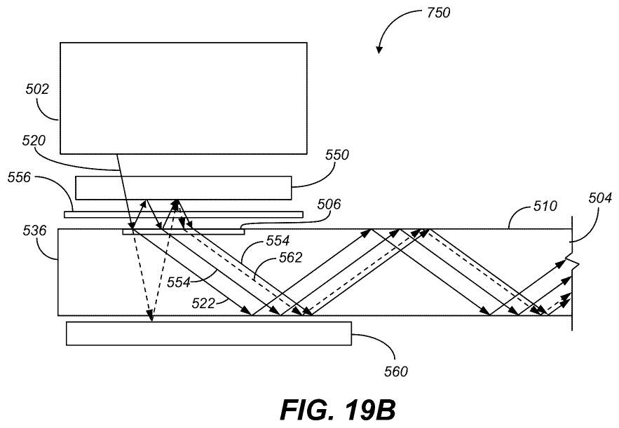

FIG. 19A shows a portion of an image light guide system 750. Like elements of the image light guide system 750 are commonly referred to with like reference numerals of previous embodiments. As illustrated in FIG. 19A, in an embodiment, a quarter-waveplate 556 is positioned optically between the optical diode 550 and the in-coupling optic 506. The quarter-waveplate 556 rotates the polarization of the image-bearing light beams.

As illustrated in FIGS. 19A and 19B, the AR display system 750 may also include a specularly reflective surface 560, such as a mirror, optically placed after the surface 512. The mirror 560 reflects at least a portion of image-bearing light beams such as, but not limited to, the zero order diffracted beams from the in-coupling optic 506 that do not meet the TIR condition to couple into the waveguide 504. A portion of the beams reflected from the mirror 506 back into the waveguide 504 may be incident on the in-coupling optic 506 and may pass through the in-coupling optic 506 to the optical diode 550. A portion of the beams reflected from the mirror 506 onto the optical diode 550 may again be reflected such that they are incident on the in-coupling optic 506 and are in-coupled as beam 522, 554 which propagate to the out-coupling optic 508 via TIR.

It is to be understood that the placement of the in-coupling optic 506 and/or the out coupling optic 508 may be on or in either waveguide surface 510 or waveguide surface 512.

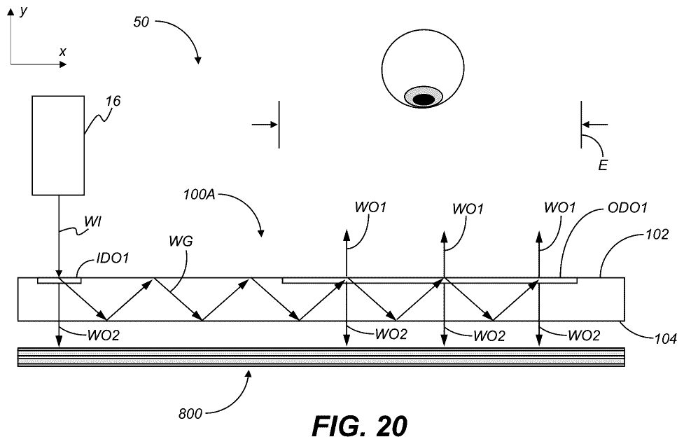

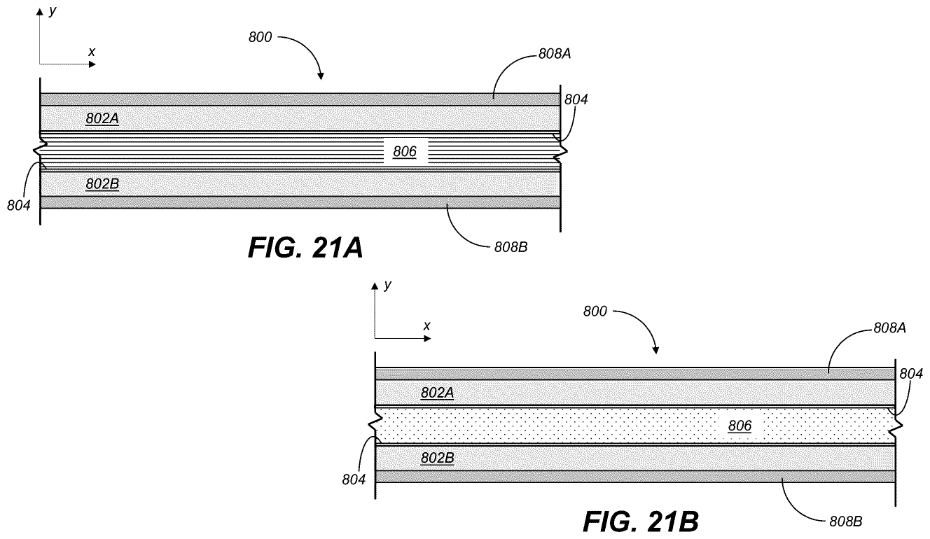

Referring now to FIG. 20, in an embodiment, the image light guide system 50 includes an optical device comprising an electrochromic filter 800. The electrochromic filter 800 may include first and second glass substrates 802A, 802B coated with a transparent conductive material 804 on the inner surfaces, respectively, thereof such that an electric field can be created between the first and second glass substrates 802A, 802B. When the electric field is ON, the liquid crystal 806 (“LC”) located between the first and second glass substrates 802A, 802B aligns in a first direction as shown in FIG. 21A, and when the electric field is OFF, the LC 806 aligns in a second, different, direction as shown in FIG. 21B. The electrochromic filter 800 works in a similar way to the liquid crystal shutter 150. However, instead of using an electric field to change the polarization of the LC 806 and obstruct the image-bearing light WO2, the LC 806 in the electrochromic filter 800 is structured so that in certain orientations of the LC 806 a dichroic filter blocks certain wavelength ranges of image-bearing light WO2. For example, when the electric field is ON, the LC 806 may act as a dichroic filter operable to block a first wavelength range of light.

In an embodiment, the LC 806 is operable across the visible spectrum of light, and the LC 806 ON/OFF state is timed such that the LC 806 is fully opaque when the image source 16 emits image-bearing light. The image source 16 may be controllable such that a portion of the frame rate includes a state in which the LEDs of the image source 16 are all OFF, and the LC 806 is controllable such that the dichroic filter is OFF and the electrochromic filter 800 is fully transparent when the LEDs are OFF. Synchronizing the image source 16 and the electrochromic filter 800 enables the transmission of light from the ambient environment to the user's eye, such that the image light guide system 50 appears transparent to the user even when propagating an image to the eyebox. By increasing the frame rate period in which the LEDs are OFF, the apparent transparency of the image light guide system 50 is increased.

In an embodiment, the LC 806 of the electrochromic filter 800 is operable across specific wavelength ranges, rather than the visible spectrum. In this embodiment, the image source 16 may be controllable such that a portion of the frame rate would include a state in which the LEDs corresponding to the specific wavelength ranges across which the LC 806 is operable are OFF, such that the image light guide system 50 is operable to transmit at least a portion of the light from the ambient environment to the user's eye. By increasing the frame rate period in which the LEDs corresponding to the specific wavelength ranges across which the dichroic filter is operable are OFF, the apparent transparency of the image light guide system 50 may be increased.

In an embodiment, the electrochromic filter 800 includes first and second polarizing films 808A, 808B located on the outer surfaces, respectively, of the first and second glass substrates 802A, 802B. The polarizing films 808A, 808B, for example, may have polarization axes generally crossed relative to one another.

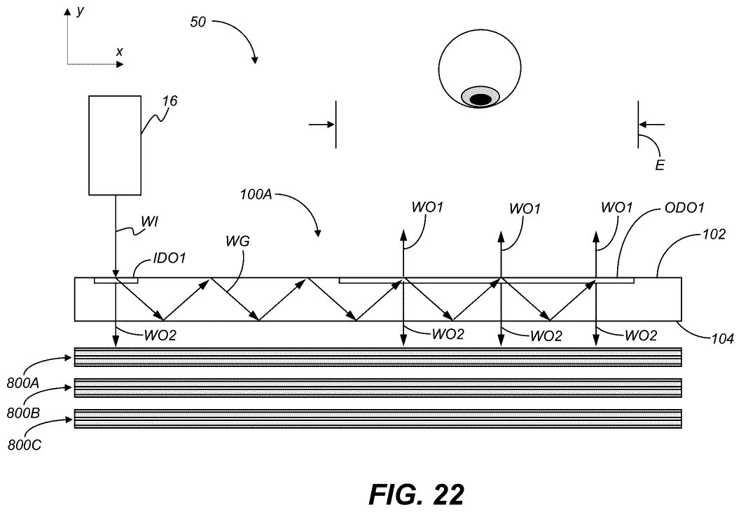

Referring now to FIG. 22, in an embodiment, the image light guide system 50 includes multiple electrochromic filters 800A, 800B, 800C. Each of the electrochromic filters 800A, 800B, 800C may be timed (e.g., with the image source 16) to work with separate subframes (e.g., portion of the frame rate) in the video signal corresponding to different wavelength ranges of the image-bearing light. For example, a first electrochromic filter 800A may be operable to block light in a first wavelength range (e.g., red), a second electrochromic filter 800B may be operable to block light in a second wavelength range (e.g., green), and a third electrochromic filter 800C may be operable to block light in a third wavelength range (e.g., blue).

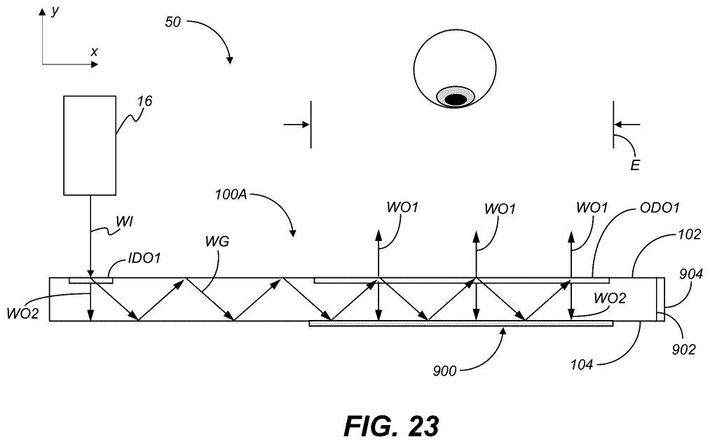

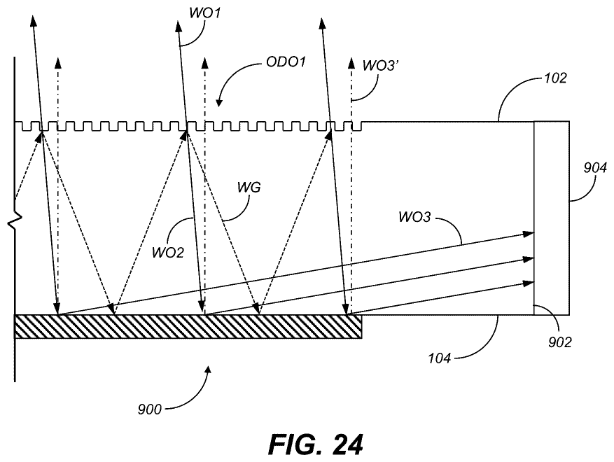

Referring now to FIG. 23, in an embodiment, the image light guide system 50 includes an optical device comprising a volume hologram 900 formed on the second surface 104 of the planar waveguide 100A. The volume hologram 900 includes diffractive elements spaced to act upon a specific wavelength range of light. As shown in FIG. 24, the diffractive elements of the volume hologram 900 are configured such that image-bearing light WO2 that is incident upon the volume hologram 900 is directed as image-bearing light WO3 into a near orthogonal direction to the image-bearing light WO2, rather than into a TIR condition. Because of the configuration of the diffractive elements of the volume hologram 900, light from the ambient environment is operable to transmit through the volume hologram 900 and the planar waveguide 100A to the user's eye. In an embodiment, one extreme field angle of the central ray of the image-bearing light WO2 that is incident upon the volume hologram 900 is directed near to perpendicular to the second surface 104 as image-bearing light WO3′ and the opposite field angle of the central ray of the image-bearing light WO2 incident upon the volume hologram 900 is directed to exit the volume hologram 900 in non-TIR conditions nearly perpendicular to the central ray of the image-bearing light WO2 as image-bearing light WO3.

In an embodiment, the image-bearing light WO2 that is incident upon the volume hologram 900 and is directed as image-bearing light WO3 into a near orthogonal direction in non-TIR conditions is directed towards an absorptive material 904 located at the end 902 of the planar waveguide 100A. For example, the absorptive material 904 may be, but is not limited to, a flat black coating or light absorbing film. In an embodiment, the angle of propagation of the image-bearing light WO3 prevents a majority of the image-bearing light WO3 from being diffracted by the volume hologram 900.

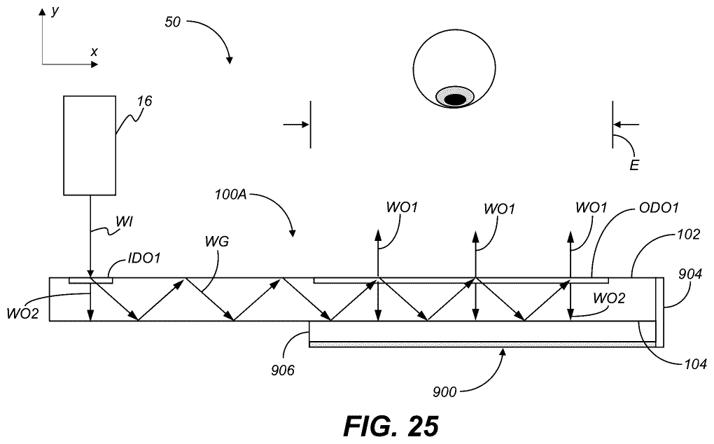

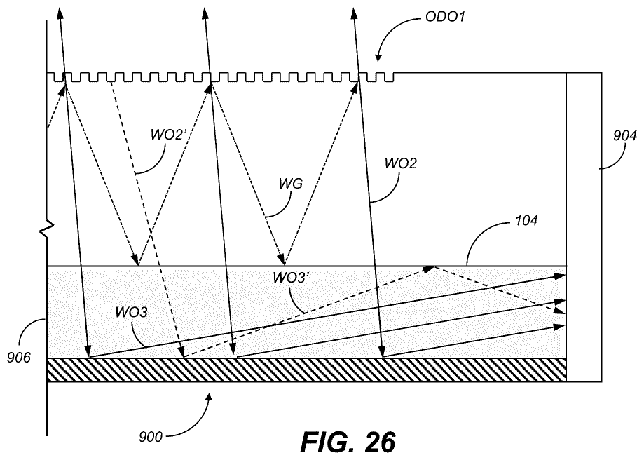

Referring now to FIG. 25, in an embodiment, the planar waveguide 100A of the image light guide system 50 includes a material layer 906 formed on the second surface 104 thereof between the volume hologram 900 and the planar waveguide substrate. As shown in FIG. 26, the diffractive elements of the volume hologram 900 are configured such that image-bearing light WO2 that is incident upon the volume hologram 900 is directed as image-bearing light WO3 into a near orthogonal direction to the image-bearing light WO2, rather than into a TIR condition. The material layer 906 enables some rays of image-bearing light WO3′ to reflect off the waveguide surface 104 en-route to the absorbing material 904.

In an embodiment, the volume hologram 900 is configured to block a first wavelength range of light, while generally permitting second and third wavelength ranges of light to be transmitted therethrough. For example, the programmable image source 16 may be operable to emit only image-bearing light WI of a first wavelength range and the volume hologram 900 is configured to block the first wavelength range while generally permitting second and third wavelength ranges of light to be transmitted therethrough.

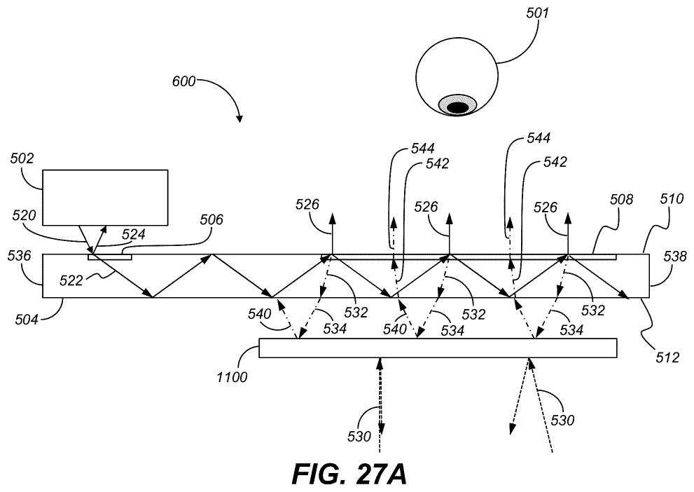

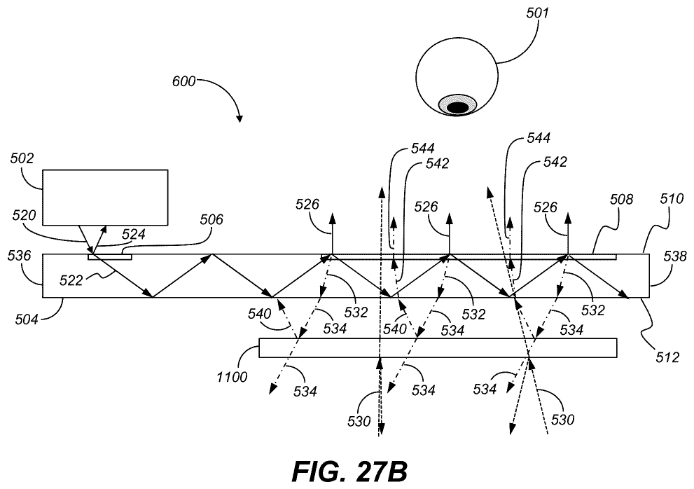

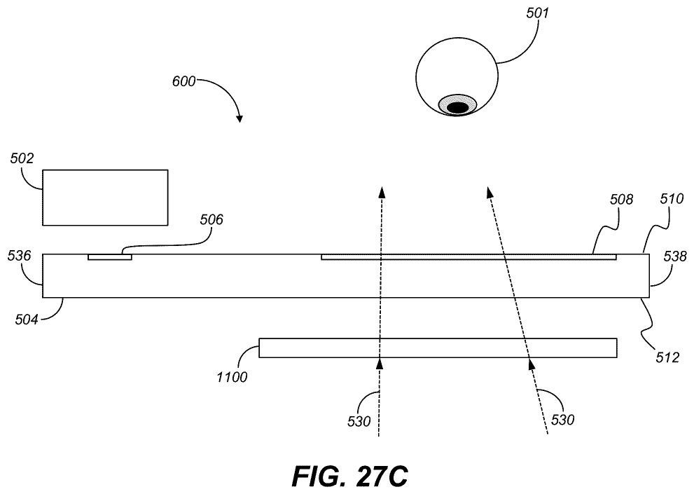

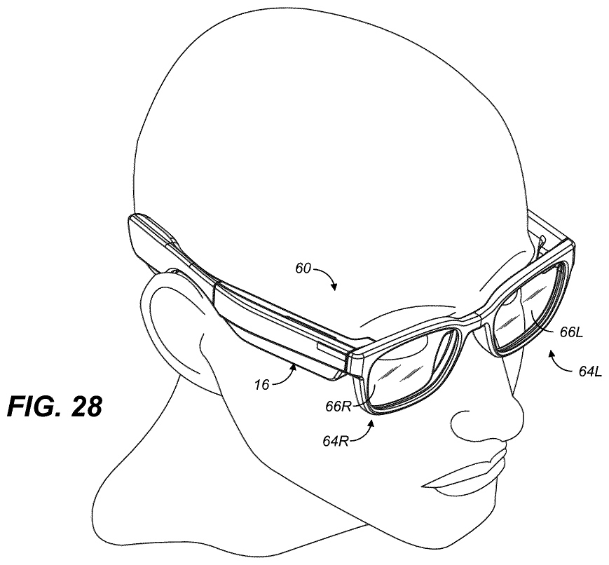

FIG. 27A shows a portion of an image light guide system 600 having one or more features and/or components previously described with regard to the image light guide system 500, 600 of FIG. 16 or FIG. 17. Correspondingly, like elements are commonly referred to with like reference numerals. In an embodiment, as illustrated in FIG. 27A, the image light guide system 600 includes an optical device comprising an electro-optically switchable mirror 1100 operable in a reflective state to reflect beams 534 exiting the parallel plate waveguide 504 through the waveguide surface 512. As illustrated in FIG. 27C, the switchable mirror 1100 is also operable in a light transmissive state to allow a portion of incident light beams 530 from the environment to pass therethrough.

In an embodiment, the switchable mirror 1100 may comprise the e-TransFlector™ developed by Kent Optronics, Inc., having a place of business at 40 Corporate Park Dr., Hopewell Junction, NY 12533. For example, the switchable mirror 1100 operates at a switching time of 10 ms-100 ms and has a reflection bandwidth range selected from 50 nm-1,000 nm. The alignment of the switchable mirror 1100 is parallel to the waveguide surface 512. The switchable mirror 1100 may cover the same area as out-coupling diffractive optic 508. In another embodiment, the area of the switchable mirror 1100 covers the area of the out-coupling diffractive optic 508 plus another portion of the waveguide surface 512. In another embodiment, the area of the switchable mirror 1100 covers the entire area of the waveguide surface 512.

Synchronizing the image source 502 and the switchable mirror 1100 enables the transmission of light from the ambient environment to the user's eye, such that the display system 600 appears transparent to the user even when propagating an image to the eyebox. As illustrated in FIG. 27C, when the switchable mirror 1100 is in a light transmissive state (as opposed to a reflective state) a portion of incident light beams or rays 530 from the environment pass through the switchable mirror 1100, the parallel plate waveguide 504, and the out-coupling optic 508 to be observed by the wearer's eye 501. In an embodiment, where the image source 502 is synchronized with the reflective/transmissive state of the switchable mirror 1100, the image source 502 does not emit image-bearing light while the switchable mirror 1100 is in a transmissive state.

As illustrated in FIG. 27B, in an embodiment, the switchable mirror 1100 is operable in a partially reflective state in which a portion of the image-bearing light beams 534 exiting the parallel plate waveguide 504 through the waveguide surface 512 are reflected back toward the parallel plate waveguide 504 by the switchable mirror 1100 as reflected beams 540 and another portion of the image-bearing light beams 534 exiting the parallel plate waveguide 504 through the waveguide surface 512 are transmitted through the switchable mirror 1100. Similarly, a portion of incident light beams or rays 530 from the environment pass through the switchable mirror 1100 and another portion of incident light beams 530 are reflected by the switchable mirror 1100. The partially reflective state of the switchable mirror 1100 has the advantage of increasing the brightness/intensity of the total light emitted from the waveguide 504 toward the wearer's eye 501 by reflecting a portion the image-bearing light beams 534 back into the waveguide 504. With the addition of the out-coupled beams 544 to the out-coupled beams 526, the virtual image that the wearer observes will be brighter than it would be without the switchable mirror 1100. Further, by reflecting a portion of incident light beams 530 from the environment, the real world image perceived by the user is decreased in intensity. Thus, the observed brightness of the virtual image may be further increased relative to the environment. As described supra, the system 600 may require less electrical power to drive the projector 502 at the desired brightness, and thus may increase battery lifetime per battery charge.

In an embodiment, the switchable mirror 1100 is operable to switch between at least the reflective state shown in FIG. 27A, the partially reflective state shown in FIG. 27B, and the light transmissive state shown in FIG. 27C. In an embodiment, the switchable mirror 1100 is configured to block a first wavelength range of light, while generally permitting other wavelength ranges of light to be transmitted therethrough. For example, the image source 502 may be operable to emit image-bearing light 520 in a first wavelength range and the switchable mirror 1100 is configured to block/reflect the first wavelength range. Utilizing the switchable mirror 1100 to block only one wavelength range of light changes the time that the switchable mirror 1100 needs to be in an ON state. Therefore, the ON/OFF timing is different compared to when trying to block all color wavelength ranges. In an embodiment, the programmable image source 502 includes a mode of operation in which only the red wavelength range is emitted, and the switchable mirror 1100 is only ON for the red wavelength range of light R part of the frame rate.

The perspective view of FIG. 28 shows a display system 60 for augmented reality viewing using one or more image light guides, image light guide systems, and/or AR display systems of the present disclosure. Display system 60 is shown as an HMD with a right-eye optical system 64R having an image light guide 66R for the right eye. The display system 60 includes an image source 16, such as a picoprojector or similar device, energizable to generate an image. In an embodiment, the display system 60 includes a left-eye optical system 64L including one or more image light guides 66L and a second image source. The images that are generated can be a stereoscopic pair of images for 3D viewing. The virtual image that is formed by the display system 60 can appear to be superimposed or overlaid onto the real-world scene content seen by the viewer through the right eye image light guide 66R and/or left eye image light guide 66L. Additional components familiar to those skilled in the augmented reality visualization arts, such as one or more cameras mounted on the frame of the HMD for viewing scene content or viewer gaze tracking, can also be provided.

Persons skilled in the art will recognize that the in-coupling diffractive optics and the out-coupling diffractive optics of the embodiments described herein may be located on the outer surface or the inner surface of the planar waveguide and can be of a transmissive or reflective type depending upon the direction from which the image-bearing light approaches the planar waveguide. Similarly, the diffractive optics could alternately be a volume hologram or other type of optical component that provides diffraction of the image-bearing light.

In addition to the foregoing, the present disclosure contemplates, without limitation, the following examples. In an example embodiment, a light secure image light guide system includes an image source operable to generate image-bearing light beams, a waveguide operable to propagate said image-bearing light beams, an in-coupling diffractive optic formed along said waveguide, wherein said in-coupling diffractive optic is operable to diffract a portion of said image-bearing light beams from said image source into said first waveguide in an angularly encoded form, an out-coupling diffractive optic formed along said waveguide, wherein said out-coupling diffractive optic is operable to expand said portion of image-bearing light beams, direct a first portion of expanded image-bearing light beams from said waveguide in an angularly decoded form in a first direction toward an eyebox, and direct a second portion of expanded image-bearing light beams from said waveguide in a second direction different from said first direction, and an optical device operable to reduce said second portion of expanded image-bearing light beams output from said image light guide in said second direction.

In another example embodiment of the light secure image light guide system said optical device comprises a liquid crystal shutter. For example, said liquid crystal shutter includes a first substrate having first and second opposing surfaces, a second substrate having first and second opposing surfaces, a first layer of conductive material located on said first substrate second surface and a second layer of conductive material located on said second substrate first surface, wherein said first and second layers of conductive material are operable to produce an electric field between said first and second substrates, a liquid crystal located between said first and second layers of conductive material, wherein said liquid crystal is operable to align in a first direction in an ON state of said electric field, and a second direction in an OFF state of said electric field, and a polarizer located on said second substrate second surface.

In an example embodiment, said polarizer located on said second substrate second surface is a second polarizer, and a first polarizer is located on said first substrate first surface. For example, said first and second polarizers have crossed polarization axes and/or in said ON state of said electric field a first linear polarization state of said second portion of expanded image-bearing light beams incident upon said liquid crystal is absorbed. Said first and second linear polarization states may be substantially orthogonal.

In another example embodiment of the light secure image light guide system said optical device comprises a three-dimensional photonic crystal having periodic variation in three axes, said image source is operable to emit image-bearing light in a first wavelength range, and said three-dimensional photonic crystal is operable to reflect light in said first wavelength range. For example, a second optical diode may be positioned optically between said image source and said in-coupling diffractive optic, wherein a portion of said image-bearing light directed from said in-coupling diffractive optic toward said second optical diode is reflected by said second optical diode toward said in-coupling diffractive optic and in-coupled thereby.

In another example embodiment of the light secure image light guide system, the optical device includes an electrochromic filter having a first substrate with first and second opposing surfaces, a second substrate with first and second opposing surfaces, a first layer of conductive material located on said first substrate second surface and a second layer of conductive material located on said second substrate first surface, wherein said first and second layers of conductive material are operable to produce an electric field between said first and second substrates, a liquid crystal located between said first and second layers of conductive material, wherein said liquid crystal is operable to align in a first direction in an ON state of said electric field, and a second direction in an OFF state of said electric field, and a polarizer located on said second substrate second surface.

In an example embodiment, said liquid crystal presents a dichroic filter operable to block a first wavelength range of said image-bearing light. For example, said electrochromic filter is opaque to said first wavelength range of said image-bearing light when said image source emits said first wavelength range of said image-bearing light.

In an example embodiment, said image source and said electrochromic filter are synchronized such that said environment is perceivable through said electrochromic filter when a virtual image is viewable within said eyebox.

In another example embodiment of the light secure image light guide system, said optical device comprises a first electrochromic filter, a second electrochromic filter, and a third electrochromic filter, wherein each said first, second, and third electrochromic filter is synchronized with said image source to block said image-bearing light during different subframes of a frame rate of said image source.

For example, said first electrochromic filter is operable to block image-bearing light in a first wavelength range, said second electrochromic filter is operable to block image-bearing light in a second wavelength range, and said third electrochromic filter is operable to block image-bearing light in a third wavelength range.

In another example embodiment, a light secure image light guide system includes an image source operable to generate image-bearing light beams, a waveguide operable to propagate said image-bearing light beams, an in-coupling diffractive optic formed along said waveguide, wherein said in-coupling diffractive optic is operable to diffract a portion of said image-bearing light beams from said image source into said waveguide in an angularly encoded form, an out-coupling diffractive optic formed along said waveguide, wherein said out-coupling diffractive optic is operable to expand said portion of image-bearing light beams, direct a first portion of expanded image-bearing light beams from said waveguide in an angularly decoded form in a first direction toward an eyebox, wherein said out-coupling diffractive optic comprises blazed grating features, and an anti-reflective coating located on a surface of said blazed grating features operable to reduce light output from said image light guide in a second direction opposite said first direction.

In an example embodiment, said blazed grating features comprise substantially right triangles, and said anti-reflective coating is located on a substantially vertical surface of said blazed grating features. For example, said anti-reflective coating is operable to destroy, via destructive interference, a subset of said image-bearing light beams incident upon said out-coupling diffractive optic to reduce a second portion of expanded image-bearing light beams from outputting from said waveguide in said second direction.

In an example embodiment, said anti-reflective coating comprises a refractive index that is a function of a geometric mean of an index of refraction of said waveguide and an index of refraction of a surrounding substance. In an example embodiment, said anti-reflective coating has a thickness substantially one-quarter wavelength of said image-bearing light.

In another example embodiment, a light secure image light guide system includes an image source operable to generate image-bearing light beams, a waveguide operable to propagate said image-bearing light beams, an in-coupling diffractive optic formed along said waveguide, wherein said in-coupling diffractive optic is operable to diffract a portion of said image-bearing light beams from said image source into said waveguide in an angularly encoded form, an out-coupling diffractive optic formed along said waveguide, wherein said out-coupling diffractive optic is operable to expand said portion of image-bearing light beams, direct a first portion of expanded image-bearing light beams from said waveguide in an angularly decoded form in a first direction toward an eyebox, wherein said out-coupling diffractive optic comprises diffractive features randomly displaced over a distribution and operable to reduce light output from said image light guide in a second direction opposite said first direction. For example, a period of said diffractive features is randomized as a function of a cosine probability distribution.

In an example embodiment, a second-order diffraction of said image-bearing light beams incident upon said out-coupling diffractive optic is suppressed, whereby light output from said image light guide in said second direction is substantially eliminated. In an example embodiment, a first-order diffraction of said image-bearing light beams incident upon said out-coupling diffractive optic is enhanced, whereby light output from said image light guide in said first direction is increased in intensity.

In another example embodiment, a light secure image light guide system includes an image source operable to generate image-bearing light beams, a waveguide operable to propagate said image-bearing light beams, an in-coupling diffractive optic formed along said waveguide, wherein said in-coupling diffractive optic is operable to diffract a portion of said image-bearing light beams from said image source into said waveguide in an angularly encoded form, an out-coupling diffractive optic formed along said waveguide, wherein said out-coupling diffractive optic is operable to expand said portion of image-bearing light beams, direct a first portion of expanded image-bearing light beams from said waveguide in an angularly decoded form in a first direction toward an eyebox, a waveplate located optically between said in-coupling diffractive optic and said image source, and a specularly reflective surface located adjacent to a surface of said waveguide opposite said image source, wherein said reflective surface is operable to reflect at least a portion of said image-bearing light beams not in-coupled by said in-coupling diffractive optic back toward said in-coupling diffractive optic.

In an example embodiment, an optical diode is positioned optically between said image source and said in-coupling diffractive optic, wherein a portion of said image-bearing light reflected from said reflective surface and directed from said in-coupling diffractive optic toward said second optical diode is reflected by said optical diode toward said in-coupling diffractive optic and in-coupled thereby.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. A light secure image light guide, comprising:
an image source operable to generate image-bearing light beams;
a waveguide operable to propagate said image-bearing light beams;
an in-coupling diffractive optic formed along said waveguide, wherein said in-coupling diffractive optic is operable to diffract a portion of said image-bearing light beams from said image source into said first waveguide in an angularly encoded form;
an out-coupling diffractive optic formed along said waveguide, wherein said out-coupling diffractive optic is operable to expand said portion of image-bearing light beams, direct a first portion of expanded image-bearing light beams from said waveguide in an angularly decoded form in a first direction toward an eyebox, and direct a second portion of expanded image-bearing light beams from said waveguide in a second direction different from said first direction; and
an optical device operable to reduce said second portion of expanded image-bearing light beams output from said image light guide in said second direction.

2. The image light guide according to claim 1, wherein said optical device comprises a liquid crystal shutter.

3. The image light guide according to claim 2, wherein said liquid crystal shutter comprises:
a first substrate having first and second opposing surfaces;
a second substrate having first and second opposing surfaces;
a first layer of conductive material located on said first substrate second surface and a second layer of conductive material located on said second substrate first surface, wherein said first and second layers of conductive material are operable to produce an electric field between said first and second substrates;
a liquid crystal located between said first and second layers of conductive material, wherein said liquid crystal is operable to align in a first direction in an ON state of said electric field, and a second direction in an OFF state of said electric field; and
a polarizer located on said second substrate second surface.

4. The image light guide according to claim 3, wherein said polarizer located on said second substrate second surface is a second polarizer, and a first polarizer is located on said first substrate first surface and wherein the first and second polarizers comprise a polarizing film.

5. The image light guide according to claim 1, wherein said image source emits image-bearing light for a period less than half of a frame rate of said image source, wherein said optical device is operable to reduce said second portion of expanded image-bearing light beams output from said image light guide system to substantially zero for said period, and wherein ambient light from an environment is transmissible through said image light guide system when said image source does not emit image-bearing light.

6. The image light guide according to claim 1, wherein said optical device comprises a three-dimensional photonic crystal having periodic variation in three axes, said image source is operable to emit image-bearing light in a first wavelength range, and said three-dimensional photonic crystal is operable to reflect light in said first wavelength range.

7. The image light guide according to claim 1, wherein said optical device comprises an optical diode operable to reflect said second portion of expanded image-bearing light beams and transmit ambient light from an environment.

8. The image light guide according to claim 7, wherein said optical diode comprises a plurality of component layers having a plasmonic material with low optical loss and a dielectric material, and wherein said plurality of component layers are fabricated on a substrate.

9. The image light guide according to claim 7, wherein said second portion of expanded image-bearing light beams incident upon said optical diode are reflected toward said waveguide, a first subset of said reflected image-bearing light beams enter said waveguide, and a second subset of said reflected image-bearing light beams are out-coupled substantially parallel to said first portion of expanded image-bearing light beams.

10. The image light guide according to claim 1, wherein said optical device comprises an electrochromic filter.

11. The image light guide according to claim 10, wherein said electrochromic filter comprises:
a first substrate having first and second opposing surfaces;
a second substrate having first and second opposing surfaces;
a first layer of conductive material located on said first substrate second surface and a second layer of conductive material located on said second substrate first surface, wherein said first and second layers of conductive material are operable to produce an electric field between said first and second substrates;
a liquid crystal located between said first and second layers of conductive material, wherein said liquid crystal is operable to align in a first direction in an ON state of said electric field, and a second direction in an OFF state of said electric field; and
a polarizer located on said second substrate second surface.

12. The image light guide according to claim 10, wherein said image source emits image-bearing light at a frame rate comprising a period in which all of a plurality of light emitting diodes of said image source are not emitting light, wherein said electrochromic filter is transparent to ambient light from an environment during said period.

13. The image light guide according to claim 1, wherein said optical device comprises volume hologram.

14. The image light guide according to claim 13, wherein said volume hologram comprises diffractive elements operable to reflect a first wavelength range of image-bearing light, wherein said second portion of expanded image-bearing light incident upon said volume hologram is directed in a near orthogonal direction, and wherein said volume hologram is transparent to ambient light from an environment.

15. The image light guide according to claim 14, further comprising an absorptive material located at an end of said waveguide, wherein said second portion of expanded image-bearing light incident upon said volume hologram is incident upon said absorptive material.

16. The image light guide according to claim 14, further comprising a material layer located on a surface of said waveguide opposite said eyebox, wherein said volume hologram is located on said material layer opposite said waveguide.

17. The image light guide according to claim 1, wherein said optical device comprises a switchable mirror operable in a reflective state to block a first wavelength range of said image-bearing light.

18. The image light guide according to claim 17, wherein said switchable mirror is operable in a partially reflective state, wherein a first subset of said second portion of expanded image-bearing light beams are reflected by said switchable mirror toward said waveguide and a second subset of said second portion of expanded image-bearing light beams are transmitted through said switchable mirror.

19. The image light guide according to claim 1, wherein the optical device is formed as an overshield operable to translate into and out of a path of the second portion of light.

20. The image light guide according to claim 19, wherein the overshield is operable to rotate about a hinge located on a frame positioned relative to the image light guide, slidably couple with a portion of the frame, or cover at least a portion of the image light guide.

21. The image light guide according to claim 1, wherein said image source emits image-bearing light for substantially 5% of a frame rate of said image source, wherein said optical device is operable to reduce said second portion of expanded image-bearing light beams output from said image light guide system to substantially zero for said period, and wherein effectively 45% of ambient light from an environment is transmitted through said optical device.
